(19) United States
(12) Patent Application Publication
(10) Pub. No.: US 2020/0162599 A1
(43) Pub. Date: May 21, 2020

(54) Audio/Video Wearable Computer System with Integrated Projector

(71) Applicant: Muzik Inc., West Hollywood, CA (US)

(72) Inventor: Jason Hardi, Beverly Hills, CA (US)

(21) Appl. No.: 16/747,926

(22) Filed: Jan. 21, 2020

Related U.S. Application Data
(63) Continuation of application No. 15/628,206, filed on Jun. 20, 2017.
Application No. 15/628,206 is a continuation-in-part of application No. 15/162,152, filed on May 23, 2016, now Pat. No. 9,992,316.
Application No. 15/162,152 is a continuation of application No. 13/802,217, filed on Mar. 13, 2013, now abandoned.
Application No. 15/628,206 is a continuation-in-part of application No. 14/751,952, filed on Jun. 26, 2015, now abandoned.
Application No. 14/751,952 is a continuation of application No. 13/918,451, filed on Jun. 14, 2013, now abandoned.
(60) Provisional application No. 62/516,392, filed on Jun. 7, 2017.
(60) Provisional application No. 62/462,827, filed on Feb. 23, 2017.
(60) Provisional application No. 62/431,288, filed on Dec. 7, 2016.
(60) Provisional application No. 62/429,398, filed on Dec. 2, 2016.
(60) Provisional application No. 62/424,134, filed on Nov. 18, 2016.
(60) Provisional application No. 62/415,455, filed on Oct. 31, 2016.
(60) Provisional application No. 62/412,447, filed on Oct. 25, 2016.
(60) Provisional application No. 62/409,177, filed on Oct. 17, 2016.
(60) Provisional application No. 62/352,386, filed on Jun. 20, 2016.
(60) Provisional application No. 61/660,662, filed on Jun. 15, 2012.
(60) Provisional application No. 61/660,662, filed on Jun. 15, 2012.
(60) Provisional application No. 61/749,710, filed on Jan. 7, 2013.
(60) Provisional application No. 61/762,605, filed on Feb. 8, 2013.

(51) Int. Cl. H04M 1/60; H04W 4/80; G06F 3/033; G06F 1/16; G06F 3/01; G06F 3/0488; G11B 27/10; G11B 27/34; H04R 1/10; H04B 1/3827; H04L 29/06; H04W 4/02; B62D 1/04; G06F 3/041; G06F 3/16; B60K 35/00

(52) U.S. Cl. CPC H04M 1/6066; H04M 1/72558; G06F 3/033; G06F 1/169; G06F 1/1694; G06F 3/017; G06F 3/04883; G11B 27/105; G11B 27/34; H04R 1/1041; H04B 1/385; H04L 65/4076; H04L 65/601; H04W 4/025; B62D 1/04; G06F 3/041; G06F 3/165; G06F 3/016; B60K 35/00; H04L 65/608; H04L 65/4084; H04R 1/1008; B60K 2370/55; B60K 2370/334; G06F 3/167; H04L 65/604; H04B 2001/3866; H04W 4/80

(57) ABSTRACT

A head mounted system can include a video camera that is configured to provide image data. A wireless interface circuit can be configured to receive augmentation data from a remote server. A processor circuit can be coupled to the video camera, where the processor circuit can be configured to register the image data with the augmentation data and combine the image data with the augmentation data to provide augmented image data. A projector circuit, coupled to the processor circuit, the projector circuit can be configured to project the augmented image data from the head mounted system onto a surface.

### CROSS-REFERENCE TO RELATED APPLICATIONS AND CLAIMS FOR PRIORITY

The present application is a continuation of U.S. patent application Ser. No. 15/628,206, filed on Jun. 20, 2017, which is related to and claims priority under 35 U.S.C. § 119(e) to U.S. Provisional Patent Application Ser. No. 62/516,392; filed on Jun. 7, 2017 in the USPTO; and to U.S. Provisional Patent Application Ser. No. 62/462,827; filed on Feb. 23, 2017, in the USPTO; and to U.S. Provisional Patent Application Ser. No. 62/431,288; filed on Dec. 7, 2016, in the USPTO; and to U.S. Provisional Patent Application Ser. No. 62/429,398; filed on Dec. 2, 2016, in the USPTO; and to U.S. Provisional Patent Application Ser. No. 62/424,134; filed on Nov. 18, 2016, in the USPTO; and to U.S. Provisional Patent Application Ser. No. 62/415,455; filed on Oct. 31, 2016, in the USPTO; and to U.S. Provisional Patent Application Ser. No. 62/412,447; filed on Oct. 25, 2016, in the USPTO; and to U.S. Provisional Patent Application Ser. No. 62/409,177; filed on Oct. 17, 2016, and to U.S. Provisional Patent Application No. 62/352,386; filed on Jun. 20, 2016 in the United States Patent and Trademark Office; and under 35 U.S.C. § 120 to U.S. patent application Ser. No. 15/162,152; filed on May 23, 2016, in the USPTO; which is a continuation of U.S. patent application Ser. No. 13/802,217; filed Mar. 13, 2013 which claims benefit of U.S. Provisional Patent Application Ser. No. 61/660,662; filed Jun. 15, 2012 and to U.S. patent application Ser. No. 14/751,952; filed Jun. 26, 2015; in the USPTO which is a continuation of U.S. patent application Ser. No. 13/918,451; filed on Jun. 14, 2013 which claims benefit of U.S. Provisional Patent Application Ser. No. 61/660,662; filed Jun. 15, 2012, and claims benefit of U.S. Provisional Patent Application Ser. No. 61/749,710; filed Jan. 7, 2013 and claims benefit of U.S. Provisional Patent Application Ser. No. 61/762,605; filed Feb. 8, 2013, the content of all of which are hereby incorporated herein by reference.

### BACKGROUND

It is known to provide audio headphones with wireless connectivity which can support streaming of audio content to the headphones from a mobile device, such as the Smartphone. In such approaches, audio content that is stored on the mobile device is wirelessly streamed to the headphones for listening. Further, such headphones can wirelessly transmit commands to the mobile device for controlled streaming. For example, the audio headphones may transmit commands such as pause, play, skip, etc. to the mobile device which may be utilized by an application executed on the mobile device. Accordingly, such audio headphones support wirelessly receiving audio content for playback to the user as well as wireless transmission of commands to the mobile device for control of the audio playback to the user on the headphones.

### BRIEF DESCRIPTION OF THE FIGURES

FIG. 1 is a block diagram illustrating an environment for operation of headphones in some embodiments according to the inventive concept.

FIG. 2 is a flowchart illustrating a method for presenting views of a user environment associated with the headphones in some embodiments according to the inventive concept.

FIG. 3 is a block diagram of a processing system included in the headphones in some embodiments according to the inventive concept.

FIGS. 4 and 5 are flowcharts illustrating methods of establishing live streaming of audio and/or video from the headphones to an endpoint in some embodiments according to the inventive concept.

FIG. 6 is a schematic representation of a composite view including video streamed from an electronic device, such as a mobile phone, combined with video and/or audio streamed from the headphones on the electronic device in some embodiments according to the inventive concept.

FIG. 7 is a flowchart illustrating methods of providing the composite view including video streamed from an electronic device, such as a mobile phone, combined with video and/or audio streamed from the headphones on the electronic device in some embodiments according to the inventive concept.

FIG. 8 is an illustration of a camera on an earcup of the headphones in some embodiments according to the inventive concept.

FIG. 9 is an illustration of a rotatable camera apparatus in some embodiments according to the inventive concept.

FIG. 10 is a block diagram of the processing system included in the headphones in some embodiments according to the inventive concept.

FIG. 11 is an illustration of a touch sensitive control surface of the headphones in some embodiments according to the inventive concept.

FIG. 12 is a flow diagram that illustrates a configuration for live streaming video/audio to a server through a local mobile device to a server that is remote from the headphones in some embodiments according to the invention.

FIG. 13 is a flow diagram that illustrates a configuration for streaming of live audio/video from the headphones over a local WiFi connection to a server that is remote from the headphones in some embodiments according to the invention.

FIG. 14 is a flow diagram that illustrates generation of a preview image provided by the headphones in some embodiments according to the invention.

FIG. 15 is a flow diagram that illustrates the configuration of an endpoint established for content sharing via a webserver integrated into the headphones in some embodiments according to the invention.

FIG. 16 is a flow diagram that illustrates the downloading of images stored on the headphones to a mobile device in some embodiments according to the invention.

FIG. 17 is a flow diagram illustrating access to an image preview function supported by the webserver hosted on the headphones in some embodiments according to the invention.

FIG. 18 is a flow diagram that illustrates streamed video/audio from the headphones using the locally hosted webserver to an endpoint at a remote server via a mobile device in some embodiments according to the invention.

FIGS. 19A-19C are schematic representations of the headphones (FIG. 19A) including first (FIG. 19B) and second (FIG. 19C) earpieces, configured to couple to the ears of a user.

FIG. 20 is a block diagram showing an example architecture of an electronic device, such as a headphones, as described herein.

FIG. 21 illustrates an embodiment of a headphone according to the inventive concepts within an operating environment.

FIG. 22 is a schematic representation of the headphones including the plurality of cameras used to determine positional data in an environment that includes a feature with six DOF in some embodiments.

FIG. 23 is a schematic representation of operations between the headphones and a separate electronic device to determine positional data for the headphones as part of an immersive experience provided by the separate electronic device.

FIG. 24 illustrates an embodiment of the headphones according to the inventive concepts within an operating environment.

FIG. 25 illustrates an embodiment for a cross-platform application programming interface for connected audio devices, such as the headphones in some embodiments.

FIG. 26 illustrates another embodiment for a cross-platform application programming interface for connected audio devices, such as the headphones in some embodiments.

FIGS. 27, 28A, 28B and 29-35 illustrate various embodiments of a remote used to control devices, such the headphones in some embodiments according to the invention.

FIG. 36 is a schematic representation of a series of screens presented on the mobile device running an application configured to connect the headphones to the application for syncing in some embodiments according to the invention.

FIG. 37 is a schematic representation of the headphones included in a telemedicine system in some embodiments according to the invention.

FIG. 38 is a schematic representation of a plurality of headphones included in a distributed system configured to detect symptoms among a population in to issue alerts based thereon in some embodiments according to the invention.

FIG. 39 is a block diagram of a wearable computer system including at least one projector in some embodiments according to the invention.

FIG. 40 is a perspective view of an earcup of a particular type of wearable computer system showing a projector integrated into the cup in some embodiments according to the invention.

FIG. 41 is a block diagram illustrating various sources of augmentation data for use in the wearable computer system shown in FIG. 39 in some embodiments according to the invention.

FIG. 42A is a schematic representation of a head wearable computer system generating a projection image onto an arbitrary object or surface in some embodiments according to the invention.

FIG. 42B is a schematic representation of a particular type of head wearable computer system embodied as audio/video enabled headphones with two integrated projectors and a camera in some embodiments according to the invention.

### DESCRIPTION OF EMBODIMENTS ACCORDING TO THE INVENTIVE CONCEPT

Systems, methods, and devices for streaming video and/or audio of a user environmental experience from headphones are described. In some example embodiments, headphones may be used to stream a user's local environmental experience or the local environment over a network by capturing an image or video of a user view with a camera included in headphones worn by the user and paired or otherwise associated with an electronic device, such as mobile phone, and paired with a wireless network. For example, a user wearing headphones having an integrated camera can capture images and/or video content of the surroundings and stream such captured content over a network to an endpoint, such as a social media server. In some embodiments, audio content may also be streamed from a microphone included in the headphones. In some embodiments, the captured content is streamed over a wireless connection to a mobile device hosting an application. The mobile application can render the captured content and provide a live stream to the endpoint. It will be understood that the endpoint can be any resource that can be operatively coupled to a network and can ingest the streamed content such as social media servers, media storage sites, educational sites, commercial sales sites, or the like.

In still other example embodiments the headphones can include a first ear piece (sometimes referred to as an earcup) having a Bluetooth (BT) transceiver circuit (also including a BT low energy circuit (BTE), a second earpiece having a WiFi transceiver circuit, a control processor, at least one camera, at least one microphone, and a user touchpad for controlling functions on the headphones. In other example embodiments the headphones are paired with a mobile device, wherein the user touchpad can be used to control features and operations of an application operating on the mobile device that is associated with the headphones. In further example embodiments the headphones are paired with communication using a wireless network. It still other embodiments, the headphones can be operate using the BT circuit and the WiFi circuit concurrently, where some operations are carried out using the WiFi circuit whereas other operations are carried out using the BT circuit.

It will be understood that although the headphones are sometimes described herein as having particular circuits located in particular portions of the headphones, any arrangement may be used in some embodiments according the present invention. Further, it will be understood that any type of wireless communications network may be used to carry out the operations of the headphones given that such a wireless communications network can provide the performance called for by the headphones and the applications that are operatively coupled to the headphones, such as maximum latency and minimum bandwidth requirements for such operations and applications. Still further, will be understood that in some embodiments, the headphones may include a telecommunication network interface, such as an LTE interface, so that a mobile device or local WiFi connection may be unnecessary for communications between the headphones and an endpoint. It will be further understood that any telecommunication network interface that provides the performance called for by the headphones and the applications that are operatively coupled to the headphones may be used. Accordingly, when particular operations or applications are described as being carried out using a mobile device (such as a mobile phone) in conjunction with the headphones, it will be understood that equivalent operations and applications may be carried out without the mobile device by using a telecommunication network interface in some embodiments.

It will be understood that the term “/” (for example “and/or”) includes either of the items or both. For example, the streaming of audio/video includes the streaming of audio alone, video alone, or audio and video.

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and the equivalent.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

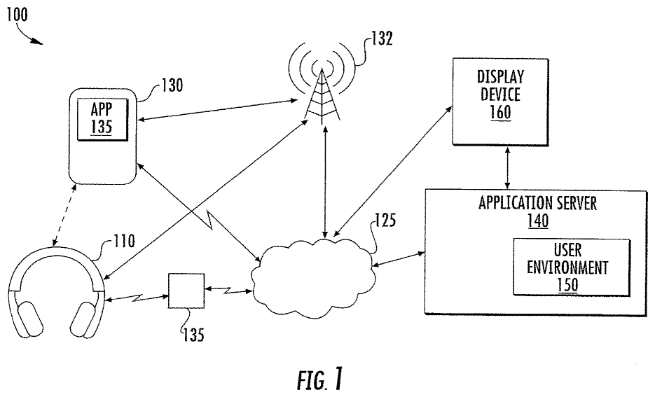

As described herein, in some example embodiments, the systems and methods for capturing and streaming a user environment are provided. FIG. 1 depicts an exemplary suitable environment 100, which includes headphones 110 associated with a mobile device 130 supporting one or more mobile applications 135, a wireless network 125, a telecommunications network 132, and an application server 140 that provides a user environment capture system 150.

In some embodiments, the headphones 110 communicate with the mobile device 130 directly or over the network 125 (such as the internet), to provide the application server 140 with information or content captured by a camera(s) and/or microphone(s) on the headphones 110. The content can include images, video, or other visual information from an environment surrounding a user of the headphones 110, although other content can also be provided. The headphones 110 may also communicate with the mobile device 130 via Bluetooth® or other near-field communication interfaces, which provides the captured information to the application server 140 via a wireless network 135 and/or the telecommunications network 132. In addition, the mobile device 130, via the mobile application 135, may capture information from the environment surrounding the headphones 110, and provide the captured information to the application server 140. Implementations of combined video capture utilizing the headphones and a mobile device are described, for example, in U.S. Provisional Patent Application No. 62/352,386, “Dual Functionality Audio Headphone,” filed Jun. 20, 2016, the content of which is incorporated herein by reference in its entirety.

The user environment capture system 150 may, upon accessing or receiving audio and/or video captured by the headphones 110, may perform various actions using the accessed or received information. For example, the user environment capture system 150 may cause a display device 160 to present the captured information, such as images from the camera(s) on the headphones 110. The display device 160 may be, for example, an associated display, a gaming system, a television or monitor, the mobile device 130, and/or other computing devices configured to present images, video, and/or other multimedia presentations, such as other mobile devices.

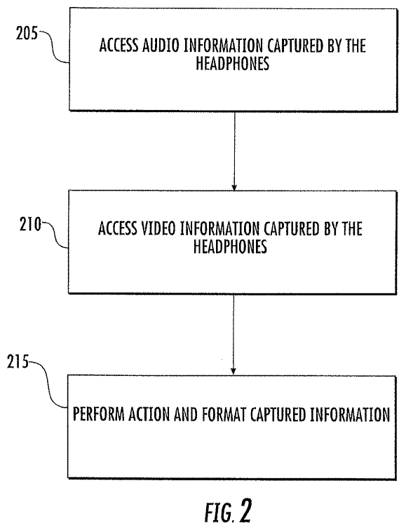

As described herein, in some embodiments, the user environment capture system 150 performs actions (e.g., presents a view of an environment) using images captured by a camera of the headphones 110. FIG. 2 is a flowchart illustrating a method 200 for presenting views of an environment surrounding using captured content. The method 200 may be performed by the user environment capture system 150 and, accordingly, is described herein merely by way of reference thereto. It will be appreciated that the method 200 may be performed on any suitable system.

In operation 205, the user environment capture system 150 accesses audio information captured by the headphones 110. For example, the headphones 110 may use one or more microphones on the headphones 110 to capture ambient noise or to capture the user's own commentary. In some embodiments a microphone may be used to reduce ambient noise according using noise reduction.

In operation 210, the user environment capture system 150 accesses images/video captured by one or more cameras on the headphones 110. For example, a camera integrated with an earcup of the headphones 110 may capture images and/or video clips of the environment to provide a first person view of the environment (e.g., visual information seen using the approximate reference point of the user within the environment).

In operation 215, the user environment capture system 150 performs an action based on the captured information. For example, the user environment capture system 150 may cause the display device 160 to render or otherwise present a view of the environment associated with images captured by the headphones 110. The user environment capture system 150 may perform additional actions including causing a delay before otherwise causing the display device 160 to present the captured images or sound. The user environment capture system 150 may add data to captured content, including location data, consumer or marketing data, information about data consumed by the user of the headphone 110, such as a song played on the headphone 110, or identification of a song played in the user environment. The user environment capture system 150 may further stream user commentary or user voice data concurrently with the captured video.

The user environment capture system 150 may perform other actions using captured visual information. In some embodiments, the capture system 150 may cause a social network platform, or other website, to post information that includes some or all of the captured visual information along with audio information played to the user wearing the headphones 100 when the visual information was captured, and/or may share the visual and audio information with other users associated with the user.

For example, the user environment capture system 150 may generate a tweet and automatically post the tweet on behalf of the user that includes a link to a song currently being played by the user, as well as an image of what the user is currently seeing while listening to the song via the audio headphone worn by the user.

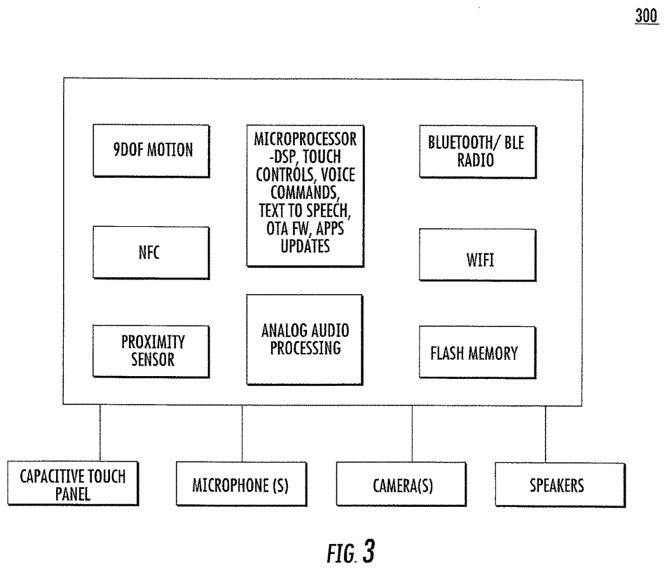

Further details regarding the operations and/or applications of the user environment capture system 150 are described with reference to FIGS. 3-7 illustrating particular embodiments according to the inventive concept.

In an example embodiment the headphones 110, as depicted in FIG. 3, include various computing components, and can connect directly to a WiFi network. The headphones 110 may include a Bluetooth connection to a mobile device executing an application that allows the user to configure the headphones to select a particular WiFi network and enter secure password information. In some embodiments, the user creates a WiFi hot spot with the mobile device, for example via a BT connection, to configure the headphones 110 to use a desired WiFi network with a secure password. In some embodiments, the headphones connect directly to a WiFi network in a home, office or other location wherein the mobile device can, via a BT connection, configure the headphones 110 to use the desired network with a secure password.

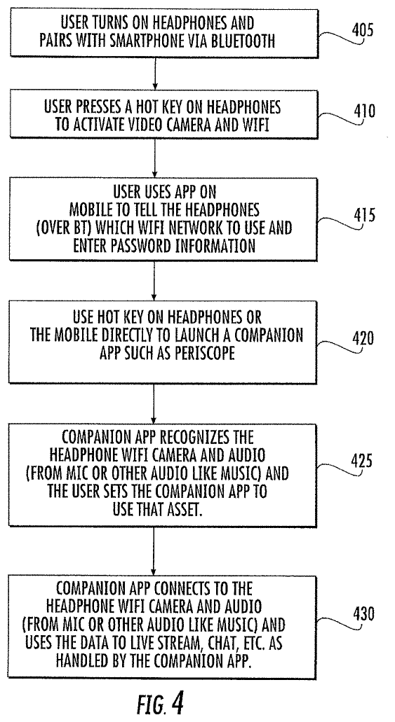

Referring to FIG. 4, when the headphones 110 are in a WiFi network with a user's mobile device, internet access the headphones 110 may appear on the network as an IP camera. Applications such as Periscope and Skype may be used with such IP cameras. A user may turn on the headphones IP camera and the WiFi using a programmable hot key located on the headphones or alternatively may activate the IP camera (and other functions) using voice recognition commands. When not in use the camera and WiFi can be shut down to preserve battery life.

In particular, in operation 405, the headphones 110 are activated so that pairing with this mobile device 110 can be established via a Bluetooth connection. In some embodiments according to the invention, the paring may be established automatically upon power on. In other embodiments according to the invention, the separate mechanism may be utilized to initiate the pairing.

In operation 410, once the paring is established, the headphones may activate the local camera and a WiFi connection to an access point or a local mobile device in response to an input to the headphones 110. In some embodiments according to the invention, the input can be a programmable “hotkey” or other input such a voice command or gesture to activate the camera. Other inputs may also be used.

In operation 415, an application on the mobile device can provide a list of WiFi networks that are accessible and available for use by the headphones 110 for streaming audio/video. In some embodiments according to the invention, the application running on the mobile device 130 can transmit the selected WiFi network to the headphones 110 using a Bluetooth low energy command. Other types of network protocols may also be used to transmit commands. Still further, the user may enter authentication information such as a password which is also transmitted to the headphones 110 from the application on the mobile device 130 also over the Bluetooth low energy interface.

In operation 420, a companion application can be launched on the mobile device 130 in response to an input at the headphones 110 or via an input to the mobile device 130 itself. For example, in some embodiments according to the invention, the companion app can be started on the mobile device 130 in response to a hotkey pressed on the headphones 110 and transmitted to the mobile device 130. For example, in some embodiments according to the invention, the companion app may be an application such as Periscope.

In operation 425, the companion application operating on the mobile device 130 can access the WiFi connection utilized by the headphones 110 to transmit the streaming video. Some embodiments according to the invention, the user may then select that WiFi connection for use by the companion appl.

In operation 430, the companion app can connect to the selected WiFi connection that carries the video and/or audio from the headphones 110 which can then be used for streaming from the mobile device 130 in whatever form that the particular companion app supports. It will be further understood that the operations shown in FIG. 4 and described herein can be controlled by the companion app via the SDK described herein which allows control of functionality provided by the headphones 110 in the application on mobile device 130 or on the headphones itself.

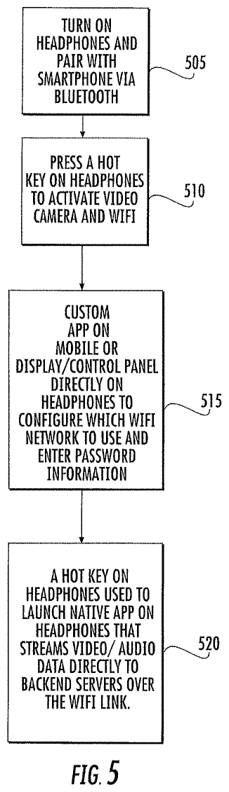

Referring to FIG. 5, a user may press a hot key on the headphones to perform various actions. A user can press one of the hot keys on the headphones to activate a companion application on a smartphone that is compatible with an IP camera such as Periscope or Skype. A user can press a hot key that automatically wakes up the WiFi and establishes a connection to a known, previously configured network. A user can press a hot key that automatically turns on WiFi, establishes a connection, opens a companion app (e.g., Periscope) on a smartphone, tablet or laptop and starts the live stream. A user can press a hot key to capture still pictures. A user can press a hot key to capture still pictures and automatically share to social networks such as Facebook and Twitter. A microphone on the headphone can include user voice data along with video data. Music and/or audio playing on the headphones can be sent along with video data.

In particular, in operation 505, the headphones 110 may be paired with the mobile device 130 in response to an input at the headphones 110, such as a hotkey, audio input, a gesture, or the like to initiate the pairing of the headphones 110 to the mobile device 130 via, for example, a Bluetooth connection.

In operation 510, the video camera associated with the headphones 110 can be activated in response to another input at the headphones 110 which may also activate a WiFi connection from the headphones 110. It will also be understood that in some embodiments according to the invention, the operations described above in reference to 505 and 510 can be integrated into a single operation or can be combined so that only a single input may be reused to take both steps described therein.

In operation 515, an application on the mobile device 130 can be activated or utilized to select the particular WiFi connection that is activated in operation 510. It will be further understood in that some embodiments according to the invention, the WiFi connection can be selected via a native application or capability embedded in the mobile device 130 such as a settings menu, etc. When the WiFi connection is established by the application running on the mobile device 130, authentication information can be provided to the headphones 110 via the application, such as a user name and password which may be transmitted to the headphone 110 over the Bluetooth connection or a low energy Bluetooth connection.

In operation 520, a native application can be launched on the headphones 110 to stream audio/video over the WiFi connection without passing through the mobile device 130.

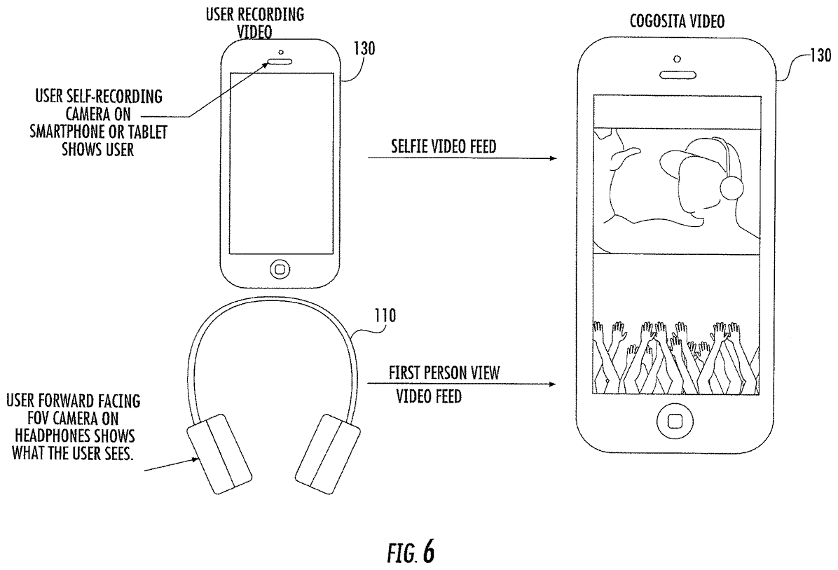

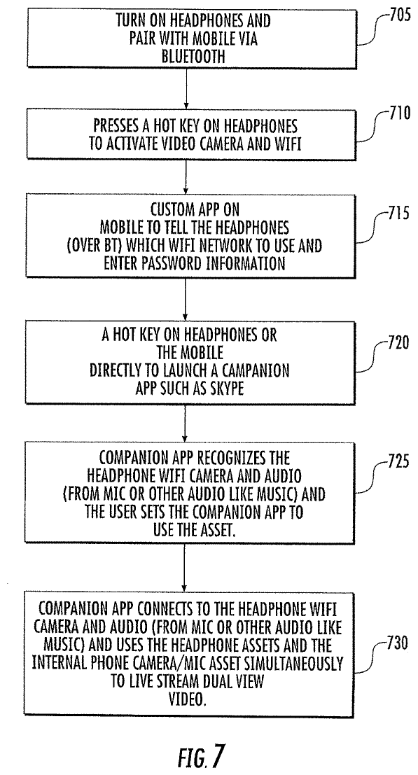

Referring to FIGS. 6 and 7, a user can capture a composite view including a video stream from a front facing camera of a mobile device 130 (i.e., a selfie view) and first-person view generated by the camera(s) of the headphones 110.

According to FIG. 6, a camera on the mobile device 130 can be used to generate what is sometimes referred to a “selfie view” which is generated as a preview and provided on the display of the mobile device 130. It will be understood that the recording by the mobile device 130 can be activated manually or automatically in response to an orientation or movement when the mobile device 130 is set into a particular mode such as a composite video mode.

As further shown in FIG. 6, at least one of the cameras associated with the headphones 110 is activated and generates a first-person view. The first-person view is generated as a video feed which is forwarded to the mobile device 130. The mobile device 130 includes an application that generates a composite view on the display of the mobile device 130. As shown on FIG. 6, the composite view can include a representation of the selfie view provided from the camera on the mobile device 130 as well as at least one first-person view provided by the video feed from the headphones 110. It will be also understood that the depiction of the composite view shown on the mobile device 130 in FIG. 6 is representative and is not to be construed as a limitation of the strict construction of the composite view. In other words, in some embodiments according to the invention composite view generated in FIG. 6 can be any view provided on the display of the mobile device 130 and includes both the selfie view as well as at least one first-person view provided by the headphones 110.

According to FIG. 7, the operations shown in FIG. 6 can be carried out as shown in operation 705-730 in some embodiments according to the invention. In operation 705, the headphones 110 can be activated whereupon a connection is established between the headphones 110 and the mobile device 130 via, for example, a Bluetooth connection.

In operation 710, the video camera located on the headphones 110 can be activated responsive to an input at the headphones 110. It will be understood that the input to the headphones 110 used to activate the video camera can be any input, such as a hotkey, press, or other input such as a gesture or voice command. Still further, a WiFi connection is established in response to the input at the headphones 110.

In operation 715, an application executing on the mobile device 130 is utilized to indicate the WiFi connections available for the streaming of video from the camera on the headphone 110. In particular, the available WiFi connections can be provided on the display of mobile device 130 using an application executing thereon whereupon the user can select the WiFi connection that is to be used for the streaming of audio/video from the headphones 110. Still further, the user may be prompted to provide authentication information for access to the first-person video view from the headphones 110.

In operation 720, an input at the headphones 110 can be utilized to launch a companion application on the mobile device 130. For example, the companion app can be launched in response to an input at the headphones 110 such as a hotkey or audio or gesture input.

In operation 725, the companion app running on the mobile device 130 accesses the selected WiFi connection to receive the streamed video from the headphones 110 (as well as audio information provided by the headphones 110) which is then directed to the companion app running on the mobile device 130. The companion app connects to the WiFi network provided from the headphones 110 to access the streamed video/audio and generates the composite image using the first-person view provided by the headphones 110 along with the selfie video feed provided from the camera located on the mobile device 130. It will be understood that the composite view can be provided by combining the selfie video feed with the first-person view provided by the headphones 110. It will be further understood that any format can be used on the display of the mobile device 130. It will also be understood that the operations described herein can be provided via an SDK that allows control of the headphones 110 by the companion application that is executed on the mobile device 130.

Accordingly, the video feed can be sent to existing and future applications running on the smartphone, tablet or laptop that support dual streaming video feed such as Periscope, Skype, Facebook, etc. Using the microphone, voice data can be sent along with the video streams. Music and/or audio data can be sent along with the video streams.

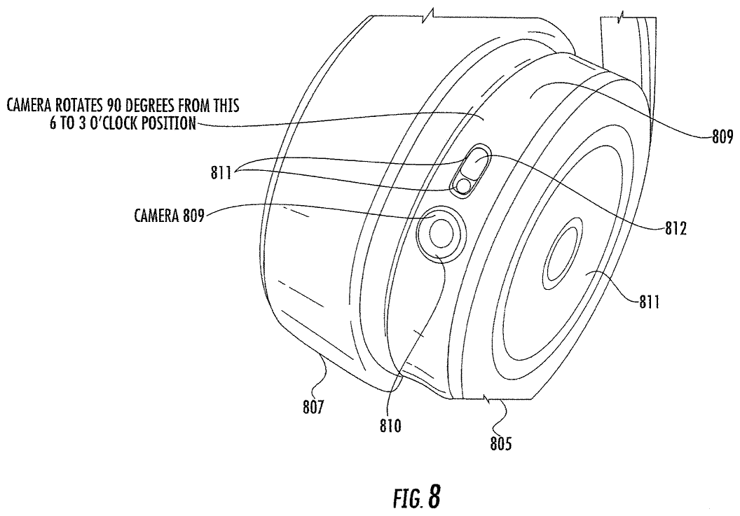

FIG. 8 is an illustration of a video camera 810 on an earcup 805 of the headphones 110 in some embodiments according to the inventive concept. Because different users may wear the headphones 110 in different orientations, or even the same user may change the orientation of the headphones 110, either by moving the position of the headphones 110 on the head, or by moving the head while wearing the headphones 110, the video camera 810 is adaptable to different orientations. In some embodiments, the video camera 810 rotates about a ring through an arc of between about 60 degrees and about 120 degrees. As illustrated, the earcup 805 comprises an earpiece 807, a camera ring 809, a touch sensitive control surface 811, an operating indication light 812. Other components, such as an accelerometer, a control processor, and a servo motor for maintaining horizontal orientation of the camera view can also be included in the headphones 110.

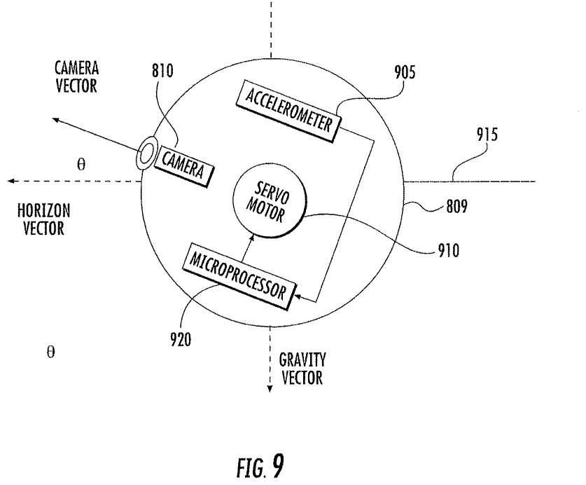

FIG. 9 is an illustration of a rotatable video camera apparatus in some embodiments according to the inventive concept shown overlaid on an orientation axis. In operation an accelerometer 905 is mounted on the rotating video camera ring 809. The accelerometer 905 provides orientation to a processor circuit 920 with respect to a gravity vector. A servo motor 910 can be controlled by the processor 910 to rotate the video camera 810 around the ring 809 to keep the camera oriented in the direction of the horizon vector. In this manner the field of view in the camera can be maintained generally to be the same as the line of sight of the user. In some embodiments image stabilization technology may be incorporated into the processing of the video data. In some embodiments, the user can activate privacy mode which can rotate the video camera 810 away from the horizon vector so that the video camera in not maintained in the same line of sight of the user. In some embodiments, the user can activate gesture mode for the headphones 110 to rotate the video camera 810 to a custom orientation for the particular user. In such embodiments, the video camera rotates to the custom orientation (such as about 45 degrees between the horizon and gravity vectors) and begins gesture processing once the rotation is complete. In this way, the user can choose the custom orientation that fits their preference or is appropriate for a particular situation such as when a user is lying down.

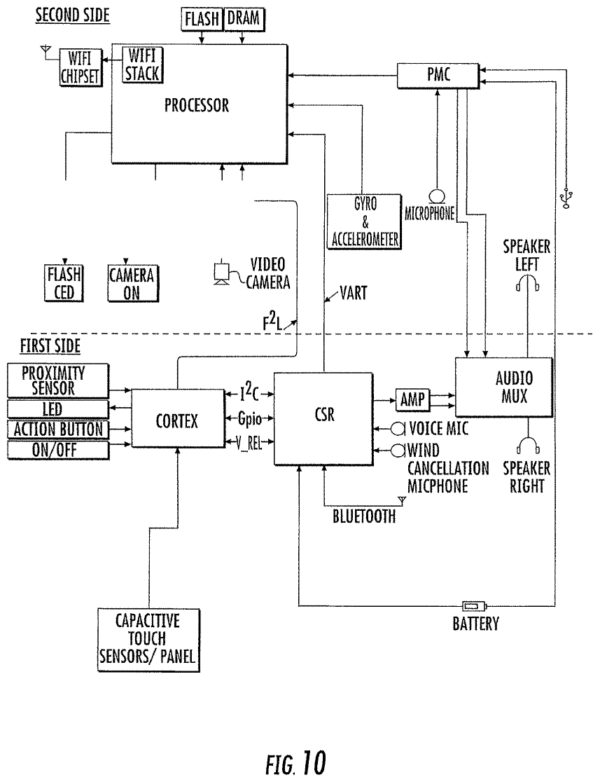

FIG. 10 illustrates an example embodiment of a particular configuration of headphones 110 suitable for streaming content such as audio and video. According to FIG. 10, the headphones 110 can be coupled to a mobile device 130 (such as a mobile phone) via a Bluetooth connection as well as a low energy Bluetooth connection (i.e. BLE). The Bluetooth connection can be utilized to stream music from the mobile device 130 to the headphones 110 for listening. The application on the mobile device 130 can be controlled over the low energy Bluetooth interfaced which is configured to transmit commands to/from the headphones 110. For example, some embodiments are going to be mentioned, the headphones 110 can include “hotkeys” that can be programmed to be associated with predefined commands that can be transmitted to the application on the mobile device 130 in response to the button push over these low energy Bluetooth interface. In response, the application can transmit music to the headphones 110 over the Bluetooth connection. It will be understood that the Bluetooth as well as the low energy Bluetooth interfaces can be provided in a particular portion of the headphones 110, such as in a right side earcup. It will be understood, however, that the interfaces described herein can be provided at any portion of the headphones 110 which is convenient.

The headphones 110 can also include a WiFi interface that is configured for carrying out higher powered functions provided by the headphones 110. For example, in some embodiments according to the invention, a WiFi connection can be established so that video streaming can be provided from a video camera on the headphones 110 to a remote server or an application on the mobile device 130. Still further, the WiFi interface can be utilized to sync media to/from the headphones 110 as well as store audio files for playback. Still further, photos and other media can be provided over the WiFi connection to a remote server or mobile device. It will also be understood that the WiFi interface can be operatively associated with a relatively high powered processor (i.e., relative to the circuitry configured to provide the Bluetooth and Bluetooth low energy interfaces described above). Still further, it will be understood that the relatively high powered processor can provide, for example, the functionality associated image processing audio/video streaming as well as functions typically associated with what is commonly referred to as a “Smartphone”.

It will be also understood that all of the function provided by the Bluetooth as well as the Bluetooth low energy interfaces can be carried out using the relatively higher powered processor that supports the WiFi interface. In some embodiments included in the invention, however, the low power operation associated with the Bluetooth and Bluetooth low energy interfaces can be separated from the relatively higher power functions carried out by the processor associated with the WiFi interface. In such embodiments, the Bluetooth/Bluetooth low energy processing can be provided as a default mode of operation for the headphones 110 until a command is received to being operations that are more suitably carried out by the processor associated with the WiFi interface. For example, in some embodiments according to the invention, the Bluetooth and Bluetooth low energy circuits can provide a persistent voice control application that listens for a particular phrase (such as “okay, Muzik”) where upon the headphones 110 transmits the command over the low energy Bluetooth interface to an application on the mobile device 130 (or to a native application in the headphones 110 or a remote application on a server). The application executes a predefined operation associated with the command sent by the headphones 110, such as an application that translates in voice data to text. In still other embodiments according to the invention, the processor associated with the WiFi interface remains in a standby mode while the Bluetooth/Bluetooth low energy circuitry remains active. In such embodiments, the Bluetooth/Bluetooth low energy circuitry can enable the processor associated with the WiFi when a particular operation associated with the processor is called for. For example, in some embodiments according to the invention, a command can be received by the Bluetooth/Bluetooth low energy circuitry that is predetermined to be carried out by the processor associated with the WiFi interface whereupon the Bluetooth/Bluetooth low energy circuitry causes the processor or exit standby mode and become active, such as when video streaming is enabled.

Furthermore, the high powered processor portion of the headphones 110 can support embedded mobile applications that are maintained in standby mode while the Bluetooth/Bluetooth low energy circuitry calls upon the higher powered processor for particular functions. Upon request, the higher powered processor may load the mobile applications that are maintained in standby mode on the headphones 110 so that operations requiring the higher powered processor may begin, such as when live streaming is activated.

As shown in FIG. 10, the headphones 110 includes a first or left earcup that may be thought of as comprising the WiFi processing. The headphones 110 further include a second or right earcup which includes the Bluetooth processing. More specifically the left earcup 1030 comprises WiFi processor 1012, such as a Qualcomm Snapdragon 410 processor, having a WiFi stack 1013 connected to a WiFi chipset 1014 and WiFi transceiver 1015. WiFi processor 1012 is also connected to additional memory such as flash memory 1016 and DRAM 1017, video camera 1020 is housed on the left earcup 1010 and connected to WiFi chipset 1014. Various LED indicators such as a flash LED 1021 and a camera on LED 1022 may be used in conjunction with video camera 1020. One or more sensors may further be housed in the left earcup 1010 including an accelerometer 1018. Other sensors may be incorporated as well, including a gyroscope, magnetometer, thermal or IR sensor, heart rate monitor, decibel monitor, etc. Microphone 1019 is provided for audio associated with video captured by video camera 1020. Microphone 1019s connected through PMIC card 1022 to the WiFi processor 1012. USB adaptor 1024 further connects through the PMIC card 1022. Positive and negative audio cables 1025+ and 1025− run from the PMIC card 1022 to a multiplexer (Audio Mux) 1040 housed in the right earcup 1030.

Right earcup 1030 includes a Bluetooth processor 1032, such as a CSR8670 processor, connected to a Bluetooth transceiver 1033. Battery 1031 is connected to the Bluetooth processor 1032 and also the PMIC card 1020 via a power cable 1034 which runs between the left earcup 1010 and the right earcup 1030. Multiple microphones may be connected to the Bluetooth processor 1032, for example voice microphone 1035 and wind cancellation microphone 1036 are connected to and provide audio input to the Bluetooth processor 1032. Audio signals are output from the Bluetooth processor 1032 to a differential amplifier 1037 and further output as positive and negative audio signals 1038 and 1039 respectively to the left speaker 1011 in the left earcup 1010 and the right speaker 1031 in the right earcup 1030.

The operation of the headphone 110 and coordination between the WiFi and the Bluetooth is accomplished using microcontroller 1050, with is connected to the WiFi processor 1012 and the Bluetooth processor 1032 via an I₂C bus 1051. In addition, Bluetooth processor 1032 and WiFi processor 1012 may be in direct communication via UART protocol.

A user may control the various functions of the headphone 110 via a touch pad, control wheel, hot keys or a combination thereof, input through capacitive touch sensor 1052, which may be housed on the external surface of the right earcup 1030, and is connected to Ule microcontroller 1050. Additional control features may be included with the right earcup 1030, such as LED's 1055 to indicate various modes of operation, one or more hot keys 1056, a power on/or off button 1057, and a proximity sensor 1058.

Due to the relative complexity of the operations involved on the headphone, including the ability to operate in a WiFi mode, a Bluetooth mode, and also in both WiFi and Bluetooth simultaneously, a number of connections are made between the various controllers, sensors, and components of the headphones 110. Running cables or busses between the two sides of the headphone presents problems as it increases the weight and limits the flexibility and durability of the headphone. In some embodiments as many as ten cables run between the left earcup and the right earcup, and may include: A battery+cable; a ground cable (battery −); Cortex ARM SDA cable; Cortex ARM SCL cable; CSR UART Tx cable; CSR UART Rx cable; left speaker+cable; left speaker−cable; right speaker+cable; and a right speaker−cable.

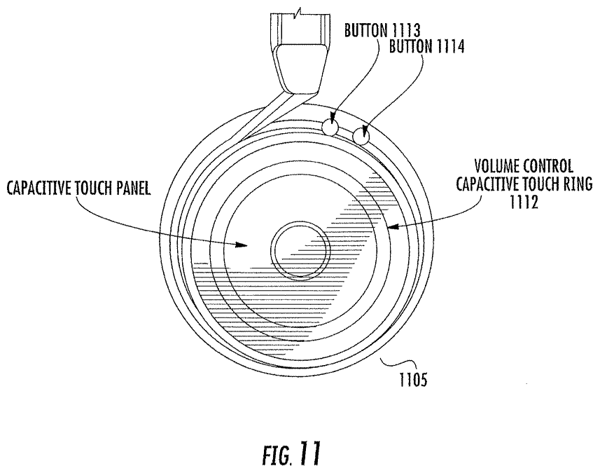

FIG. 11 illustrates an example of the capacitive touch panel (sensor) 1110 used in conjunction with the capacitive touch sensor 1052 described above. As depicted, earcup 1105 includes capacitive touch panel 1110 having capacitive touch ring 1112 and a first button 1113 and a second button 1114. Various user controls can be programmed into the headphone. Table 1 provided below gives examples of programmed user controls.

Touch Panel

| Desired Action | User Gesture | User Feedback |
|---|---|---|
| Next track | Swipe forward on touchpad | Track changes to next track |
| Previous track | Swipe backwards on touchpad | Track changes to previous |
| | | track |
| Volume up | User moves finger clockwise | Volume increases. User hears |
| | on capacitive touch ring | audio tone of increasing |
| | | loudness (to max) |
| | | corresponding to volume level |
| Volume down | User moves finger counter- | Volume decreases. User hears |
| | clockwise on capacity touch | audio tone of decreasing |
| | ring | loudness (to min) |
| | | corresponding to volume level |
| Change LIVE modes: | User swipes up or down to | Voice tells user: |
| Camera Mode | traverse through mode options | “Camera Mode” |
| Video Mode | | “Video Mode” |
| Periscope Mode | | “Periscope Mode” |
| Flashlight Mode | | “Flashlight Mode” |
| Send HOT KEY to | User touches the center of the | Audible indication. |
| smartphone application in | touch panel. | |
| Bluetooth mode | | |
| Share song information to | User touches the center of the | Audible indication |
| social networks directly from | touch panel | |
| headphones when running | | |
| Spotify on the headphones in | | |
| WiFi mode. | | |

Table 2 below provides example user controls associated with the first and second buttons.

| | | |
|---|---|---|
| Desired Action | User Gesture | User Feedback |

Button 1 Functionality (Basic Bluetooth Headphone Functions)

| | | |
|---|---|---|
| Turn headphones ON (from | Long 3 second hold and press | LED on button turns flashing |
| OFF state) | | blue, headphones say “Pairing |
| | | Mode.” Headphones will auto- |
| | | paid if previously paired |
| | | Bluetooth devices are |
| | | available. When headphones |
| | | are paired the LED is solid |
| | | Blue. |
| Turn headphones OFF (from | Long 3 second hold and press | LED turns off |
| ON state) | | |
| Answer incoming call | Short press during incoming | Call started |
| | call | |
| Hang-up current call | Short press during active call | Call ends |
| Pause/Play current track | Short press (when no active or | Music pauses/plays |
| | incoming call) | |
| Activate Siri/Google Voice | Two Short Presses | Tone indicated Google Voice |
| | | or Siri is listening waiting for |
| | | commands. |
| Charge Headphones | user plugs in USB charging | LED Flashes Red until fully |
| | cable | charged. Once charged, LED |
| | | turns solid green until it's |
| | | unplugged. Once unplugged |
| | | the LED turns off. |
| Alert user of low-battery | N/A | Yellow LED instead of Blue |
| | | LED. Periodic voice reminder. |

Button 2 Functionality

| | | |
|---|---|---|
| Snap a photo while in | Short press Button 2 | User hears camera shutter |
| “Camera Mode” and store/ | | noise and “Photo Shared” |
| share to pre-configured | | |
| places. | | |
| Record/Stop Recording a | Short press Button 2 | User hears “Video Recording” |
| video while in “Video Mode” | | and periodic beeps to let them |
| and store/share to pre- | | know they are still recording. |
| configured places. | | When user stops recording |
| | | they hear “Video Shared.” |
| Start/Stop LIVESTREAM to | Short press Button 2 | User heard “Periscope |
| Periscope while in “Periscope | | LIVESTREAM Started” and |
| Mode” using pre-configured | | periodic beeps to let them |
| settings. | | know they are still live |
| | | streaming. When the user |
| | | stops the Periscope |
| | | LIVESTREAM they hear |
| | | “Periscope LIVESTREAM |
| | | Stopped.” |
| Turn flashlight on/off while in | Short press Button 2 | User sees flashlight turn on |
| “Flashlight Mode” | | and off. |
| Active Muzik Voice | Two short presses on Button 2 | Unique audio tone lets users |
| Commands (NowSPeak) | | know that headphones are |
| | | waiting for a voice command |

Additional examples and explanation of control functions are disclosed in U.S. patent application Ser. No. 14/751,952 titled “Interactive Input Device,” filed Jun. 26, 2016 and incorporated herein by reference in its entirety.

In another example embodiment, and in addition to user controls input via the capacitive touch panel, the headphone may accept control instruction by voice operation using a voice recognition protocol integrated with the control system of the headphone. Table 3 below provides examples of various voice commands for control of the headphone and associated paired mobile device.

Voice commands

| Voice command | Action |
|---|---|
| Camera mode | Switch to camera mode |
| Music mode | Switch to music mode |
| Share mode | Switch to share mode |
| Answer | Answer incoming call |
| Ignore | Send incoming call to voicemail |
| Hang up | Hang up current call |
| Redial last | Redial last number called |
| Check battery | Say battery level in hours remaining |
| Play | Start current song |
| Pause | Pause current song |
| Volume up | Raise volume 2 levels |
| Volume down | Lower volume 2 levels |
| Next track | Advance to next track |
| Last track | Replay last played track |
| Start over | Start current song over |
| Mute | Mute volume |
| Share Facebook | Post current song on Facebook |
| Share Twitter | Tweet current song |
| Favorite | Add current song to favorites section in active app |
| Playlist | Start playing playlist in current app |
| Shuffle | Shuffle song in active playlist |
| Launch Muzik Connect | Launch Muzik Connect command and control app |
| Launch Muzik Live | Launch Muzik Live video management app |
| Launch Spotify | Launch Spotify app |
| Launch Twitter | Launch Twitter app |
| Launch Periscope | Launch Periscope app |
| Launch Vine | Launch Vine App |
| Say song info | Speak current song metadata (artist/album/track |
| Save song | Save current song into the app “favorites section” in which it |
| | is being listened |
| Camera on | Turn on all HR functionality (HR, gyro, etc.) |
| Camera off | Turn off all HR functionality (HR, gyro, etc.) |
| Muzik (1, 2, 3, 4) | Send currently configured command for that virtual button, |
| | configured in app (e.g., tuning modes, speed dial numbers) |
| Headphone music | Sources music stored on the headphones |
| Smartphone music | Sources music from the smartphone |
| Pic | Active camera and take still shot |
| Post Facebook | Post last still pic on Facebook |
| Start video | Place headphones in camera mode and start recording video |
| Stop video | Stop recoding video |
| Stream Periscope | Place headphones in camera mode, start recording, activate |
| | Periscope, and start streaming |
| Stop streaming Periscope | Stop streaming, but continue recording |
| Hi Siri | Activate Siri |
| Hey Google | Activate Google Speak |
| Post Instagram | Post last still pic on Instagram |
| Tweet pic | Tweet last still pic |

In an example operation the user headphone is paired via a wireless connection either Bluetooth or Wifi or both, to a mobile device running an application for sharing the images and audio captured by the headphone with third party applications running on the internet.

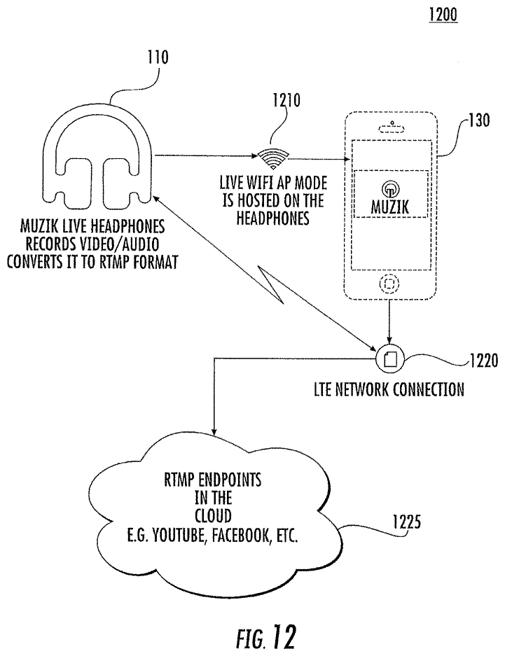

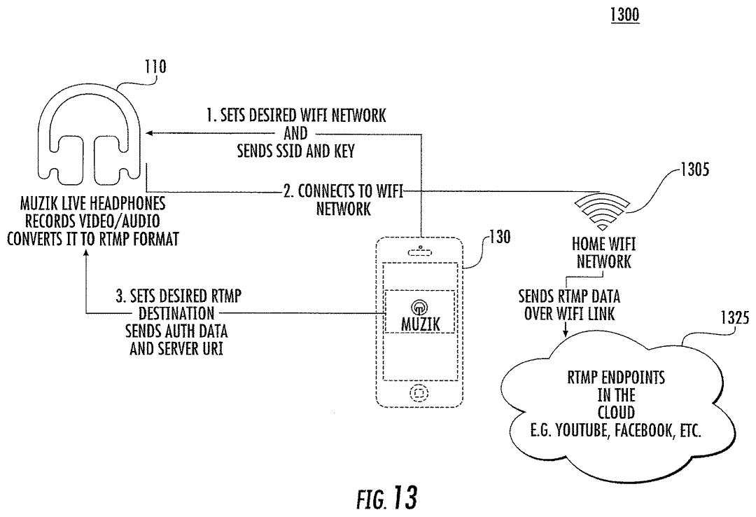

FIGS. 12 and 13 illustrate examples for sharing audio and video captured by the camera and microphones on the headphones 110. Upon initiation of the video capture on the headphone, the left side of the headphones uses FFMPEG alongside of Android MediaCodec to create a suitable RTMP stream for use on Live Streaming Platforms. The RTMP Server JNI bindings and helper code to Android are derived from Kickflip.io's SDK. The RTMP Server may be used in two ways: first connected through a user environment capture WIFI AP using a relay app on the mobile device as illustrated in FIG. 12. In this example the headphone records video/audio and converts it to RTMP format. The converted audio/video content is transmitted via a WiFi connection to the mobile device that is running a program to share the converted content to the Internet. The mobile device then shares the converted content via a cellular connection, such as an LTE connection to RTMP endpoints on the Internet or Cloud such as Youtube, Facebook, Periscope, etc.

According to FIG. 12, the headphones 110 can provide low latency video feed as described hereinabove in some embodiments according to the invention. According to FIG. 12, the headphones 110 can include a real time message protocol (RTMP) server that is configured to accept the video/audio stream generated by the camera associated with the headphones 110 and produce data for the audio/video stream in the packet format associated with the RTMP protocol. It will be understood that although RTMP is described herein as being used for streaming of audio/video, any message protocol that provides sufficiently low latency real time video from the headphones 110 to a destination endpoint can be utilized. Still further, the message protocol can be supported by a wide range of services that ingest video for posting or streaming.

As further shown in FIG. 12, the streaming audio/video provided in the RTMP packetized format is provided to the mobile device 130 over an access point WiFi connection 1210 generated by the headphones 110. The mobile device 130 includes an application that is configured to relay the packetized RTMP data for the audio/video stream to a telecommunications network connection 1220 (i.e., such as an LTE network connection). It will be further understood that the mobile device 130 can include an additional application that provides for authentication of the user's account that is associated with an endpoint for the video streaming. For example, in some embodiments according to the invention, where the headphones 110 are configured to generate a live video stream for Facebook live, a Facebook application can be included on the mobile device 130 so that the user's account can be authenticated so that when the video stream is forwarded to the endpoint (i.e., the user's Facebook page) the server can ingest the RTMP formatted audio/video stream associated with the user's account. As further shown in FIG. 12, the RTMP packetized format of the audio/video feed is forwarded to the identified endpoint 1225 for the livestream via the LTE network connection. In some embodiments according to the invention, the RTMP packetized data format is forwarded directly to the telecommunications network 1220 (i.e., such as a LTE network connection) without passing through the mobile device 130. Accordingly, the headphones 110 can stream the packetized audio/video directly to the LTE network connection shown in FIG. 12 which is then forwarded to the identified endpoint 1225 without use of the mobile device 130. It will be understood, however, that the authentication described above in reference to the endpoint associated with the user's account is still provided by an application, for example, on the headphones 110.

In the second example, the headphone is connected directly to a local WIFI network, as illustrated in FIG. 13. Utilizing the direct WiFi connections directly connects the user environment capture feature on the headphone to the Internet to allow usage of the cloud-based endpoint, the user sets the desired WiFi network connections between the Headphone and local WiFi network. In some embodiments this is done with an app hosted on the mobile device to enter the SSID and keys. In other embodiments this connecting the Headphone to the local WiFi network may be automated after initial setup. After connecting to the local WiFi network, the mobile device sets the desired RTMP destination and sends the authentication data and server URL to the headphone. The headphone records the video and audio content and converts the content to RTMP format. The headphone then sends the RTMP formatted content directly to the RTMP endpoints via the local WiFi connection.

According to FIG. 13, the RTMP packetized audio/video stream is generated by the headphones 110 connected to a WiFi network without channeling through the mobile device 130 in some embodiments according to the invention. According to FIG. 13, the application running on the mobile device 130 can establish the desired WiFi network 1305 for streaming of the RTMP packetized data using, for example, a Bluetooth connection and identifying the particular WiFi network 1305 to be used. Still further, the application on the mobile device 130 can also set the destination endpoint for the RTMP packetized data generated by the headphones 110. In addition, the application can provide user authentication and identification to the headphones 110 for inclusion with the RTMP packetized data over the WiFi network. As further shown in FIG. 13, the RTMP packetized audio/video data is provided directly to the RTMP endpoint via the WiFi without channeling through the mobile device 130 in some embodiments according to the invention.

In some example implementations the user may desire to preview the video feed being sent over the internet to the RTMP endpoints. A preview method is provided for delivering a live feed from the camera to the mobile device to function as a viewfinder for the camera. The preview function encodes video with MotionJPEG. MotionJPEG is a standard that allows a web server to serve moving images in a low latency manner. The Motion JPEG utilizes methods from the open source SKIA image Library.

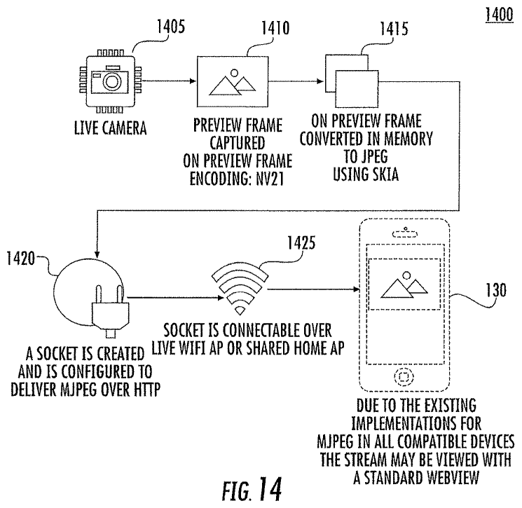

FIG. 14 illustrates a process to preview the image recorded on the headphone camera 1405. The preview frame from the camera is captured/encoded and a processor on the headphone/110 converts the preview frame 1410 in memory to MotionJPEG using SKIA 1415. A socket 1420 is then created and configured to deliver the MotionJPEG over an internet HTTP connection. The socket is connectable over the WiFi network 1425 using a purpose built app on the mobile device 130 or using an off the shelf app such as the Shared Home Ap. The preview stream is then viewable on the mobile device as a standard webview.

It will be appreciated that in some example embodiments the headphone of the present disclosure hosts an HTTP Server. The server is configured to be used as a method for controlling and configuring the user environment capture and sharing features of the camera enabled headphone, via a HTTP POST with JSON.

Since the light web server on the headphone essentially creates a web server that is embedded in the headphones 110 there are many applications for this technology, including but not limited to: Personalized Live Streaming to be consumed by one or more friends via social media; Electronic News Gathering for Television Networks; Virtualized spectators at concerts, sports, or other activities. This basically allows one to see the event through the eyes of the user of Live; Personalized decentralized websites for users of the product; Personalized decentralized social media profiles for users of the product; and Personalized decentralized blogging platform for users of the product. Indeed with web server functionality on the headphone, the user is able to capture images for products and access web based services for product identification and/or purchase. The user may use many different web or cloud based applications such as CQR Code scanning applications, group chatting functions, and more. With integration with the user control features, in some applications and embodiments, the user may fully operate with cloud based applications and web based features without a graphic interface. The headphone web server also facilitates configuration of the RTMP destination in the content sharing application of the present invention.

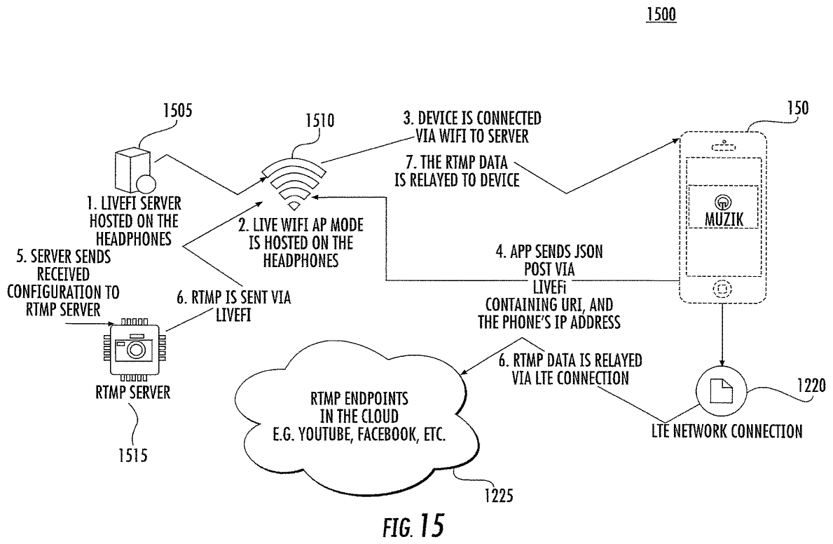

According to FIG. 15, a webserver 1505 is hosted on the headphones 110 and can be accessed by an application on the mobile device 130. In particular, the webserver 1505 on the headphones 110 can establish a WiFi access point mode network 1510 over which the application on the mobile device 130 can be contacted. The application on the mobile device 130 can forward information that is to be used in a live video feed (such as an endpoint 1225 at which live video is to be ingested). The communication can also include an address of the mobile device 130 on which the application is executing. The information is transmitted to the webserver 1505 over the WiFi access point mode network 1510 which is then forwarded to the RTMP server 1515 located on the headphones 110. The RTMP server 1515 generates the live video stream which is forwarded to the mobile device 130 using the information forwarded to the webserver 1505. The RTMP packetized data is relayed to the application on the mobile device 130 using the address of the mobile device 130 and also including the endpoint 1225 information associated with the live video feed. The application on the mobile device 130 can reformat the live video feed which can then be forwarded to the endpoint 1225 over a communications network 1220, such as an LTE network connection in some embodiments according to the invention.

FIG. 15 illustrates an example of this process. With the web server hosted on the headphone the user environment sharing application is hosted on the headphones. The user's mobile device is connected via the WiFi network to the headphone server. The mobile device then sends a post containing the URL and the phone's IP address to the server on the headphone. The server the sends the received mobile device configuration to the RTMP server. The RTMP server send converted RTMP data via the app hosted on the headphone to the mobile device. The mobile device can then send the RTMP data to RTMP endpoints via a cellular connection such as an LTE connection.

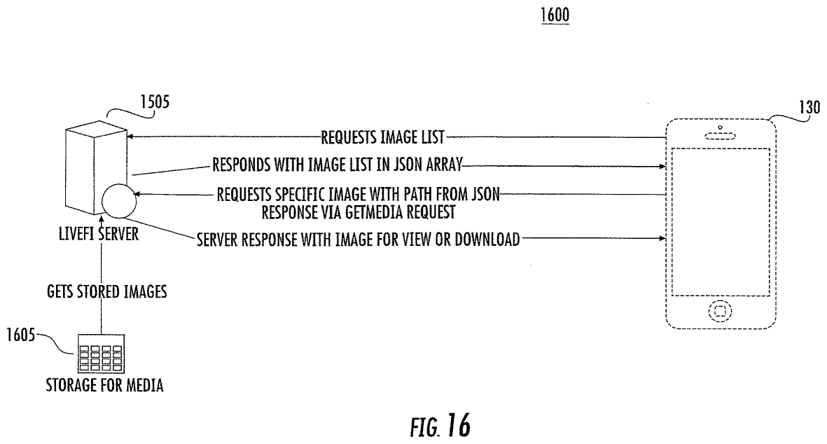

The headphone server also facilitates downloading images from the headphone to the mobile device. FIG. 16 illustrates an example of such a process. The mobile device sends via the WiFi connection a request to the headphone server for an image from an image list stored on storage media. The server responds with the image list in JSON Array. The mobile device requests a specific image with path from JSON, the response uses Via getMedia Request. The server responds with the image for viewing on the mobile device or for downloading.

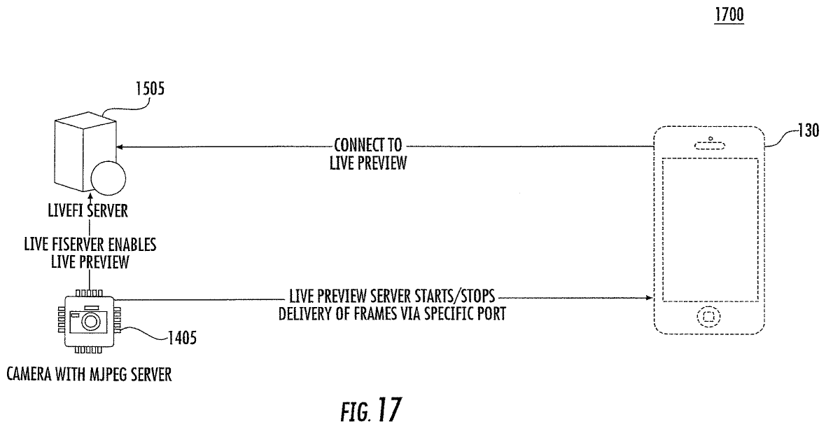

As shown in FIG. 17, the headphone server 1505 may also provide for enabling and/or disabling the image preview function of the user environment capture system. The mobile device may request an on/off preview function command from the mobile device to the headphone server the server enables or disables the preview function with the associated content configuration described herein. The server then starts/stops delivery of frames via the preview function.

In some embodiments according to the invention, the connection to the live preview can be established without a preliminary request as described above. In such embodiments, the application on the mobile device 130 sends a signal to the server 1505 to access the live preview which is generated by the camera 1405 on the headphones 110. The preview is then forwarded to application on the mobile device 130 by the camera 1405. Mobile device 130 which in turn can reformat, receive the media and is forwarded to the identified endpoint via an LTE network connection. It will be understood, however, that other types of telecommunication networks can be used.

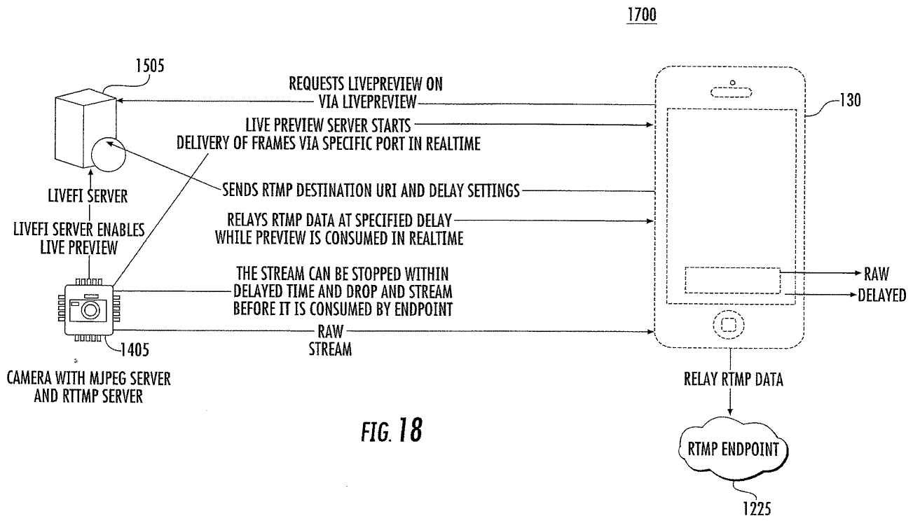

A potential problem for live streaming of audio and video is the propensity for bad actors to disrupt the captured activity. In some applications of the streaming functions associated with the present disclosure a time delay may be added to the to the outgoing stream and pausing or canceling the stream based upon what is being seen via the real-time content preview stream. The addition of this delay is analogous to what professional television networks use to censor potentially disturbing content. Using this delay in the content streaming will allow content creators to ensure the quality of their live content before it hits the screens of their viewers. FIG. 18 illustrates an example use case for providing a delay in the streaming content. The user requests to enable the streaming preview function. Tile request is sent from tile mobile device to the headphone serve. The headphone server enables the preview function. The headphone server starts delivery of preview frames in tile proper formatting in real-time. The mobile device then sends the RTMP endpoint destinations and delay settings to the headphone server. The headphone sever configures the MotionJPEG sever and RTMP Server to relay the RTMP data to the mobile device at a specified delay while the preview is consumed in real-time. The RTMP stream can be stopped within the delayed time and drop the stream before it is consumed by tile RTMP endpoint. The mobile device streams the delayed RTMP content to the RTMP endpoints via a cellular connection such as an LTE connection. In some embodiments the blocked RTMP stream can be resumed once the disturbing content is out of the picture.

In addition to video streaming, the current configuration, including the headphone having a light web server allows headphones to identify each other as an RTMP endpoint. In this manner, headphones can stream audio data to each other. For example, if two or more headphones are connected via a local WiFi network, each headphone can be identified as an RTMP endpoint. This enables voice communication between the connected headphones. Example scenarios include networked headphones in a call center, a coach in communication with team members, managers in connect in employees, or any situation where voice communication is desirable between connected headphones.

In a further example implementation, a headphone may be provided without a camera but with all the same functionality above. This may be advantageous for in ear applications, or for sport applications. Audio content, and other collected data from the user (e.g., accelerometer data, heart rate, activity level, etc.) can be streamed to an RTMP endpoint such as a coach or social media members.

In some alternative embodiments according to the invention, a raw stream can be provided from the camera 1405 as the RTMP data without a specified delay. The raw stream is received by the application on the mobile device 130 and is processed to generate a delayed version of the raw stream which is analogous to the relayed RTMP data provided at the specified delay as described above. Therefore, the same functionality can be provided in the delayed stream produced by the application such that the stream can be stopped within the delayed time before it is consumed by the endpoint. However, as further shown in FIG. 18, the application can produce an alternative raw video stream which is unedited for content. Accordingly, in some embodiments according to the invention, consumers may choose between raw or delayed streamed content.

As further appreciated by the present inventive entity, the headphones 110 may provide more electronics “real-estate” than is typically utilized by converting the headphones, which goes unused. Moreover, the capability of the headphones to communicate with, as well as the typical proximity of the headphones to, the user's other electronic devices can offer the opportunity to augment operations of those other electronics using hardware/software associated with the headphones 110 thereby offering ways to complete or enhance operations of the other electronic devices. In some embodiments, the headphones 110 can be configured to assist a separate portable electronic device by offloading the determination of positional data associated with the headphones, which may in-turn, be used to determine positional data for the user, which may improve the user's experience in immersive type applications supported by the separate mobile electronic device. Other types of offloading and/or augmentation can also be provided. It will be understood that the electronic device can be the mobile device 130 described herein and that the headphones 110 may operate as described herein without the electronic device.

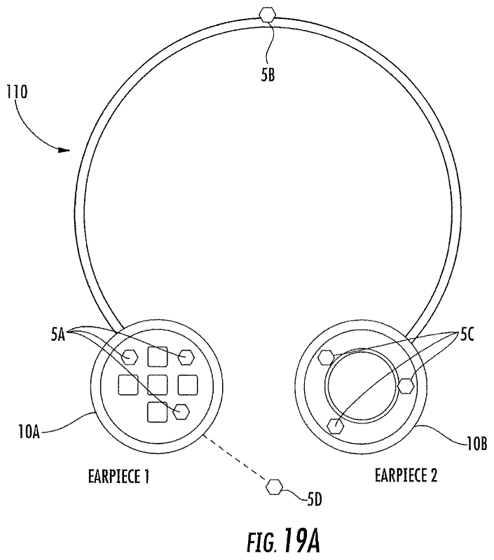

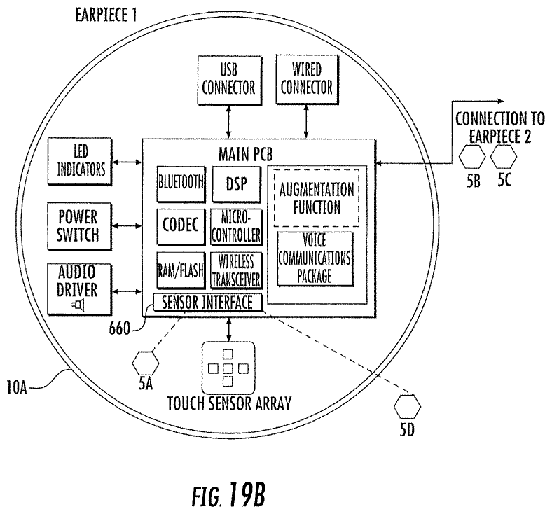

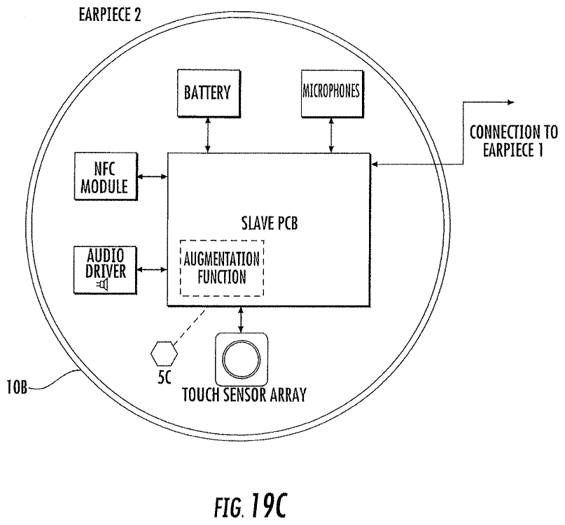

FIG. 19 is a schematic representation of the headphones 110 including left and right earpieces 10A and 10B, respectively, configured to couple to the ears of a user. The headphones 110 further include a plurality of sensors 5A-5D including the video camera and microphones described herein. In some embodiments, the sensors 5A-5D may be configured to assist in the determination of positional data. The positional data can be used to determine a position of the headphones 110 in an environment, with six degrees of freedom (DOF).

The sensors 5A-5D can be any type of sensor used to determine location in what is sometimes referred to as an inside-out tracking system where, for example, the sensors 5A-5D receive electromagnetic and/or other physical energy (such as radio, optical, and/or ultrasound signals etc.) from the surrounding environment to provide signals that may be used to determine a location of the headphones with six DOF. For example, the plurality of sensors may be used to determine a head position of the user based on a determined position of the headphones 110.

As shown in FIG. 19A, the plurality of sensors 5A-5D can be located on any portion of the headphones or proximate to the headphones. For example, the sensors 5A are on the left earpiece 10A, the sensors 5B are on the headband, the sensors 5C are on the right earpiece 10B, and the sensors 5D are separated from the headphones 110 but located proximate enough to be in wireless or wired communication with augmentation functions in the headphones 110. In some embodiments, the sensors 5D can be located with separate electronic devices that may be worn by the user and may be utilized as part of an immersive experience provided by the separate electronic device, such as a bracelet, necklace, wand, of the like. It will be further understood that the location of the sensors 5A-5D on the headphones can be selected so that the sensors can sufficiently receive electromagnetic and/or other physical energy as part of the inside-out tracking system to determine positional data for the headphones with six DOF. Though FIG. 19A illustrates a particular configuration and location of the sensors 5A-5D, it will be understood by one of skill in the art that other configurations of the sensors are possible without deviating from the inventive concept.

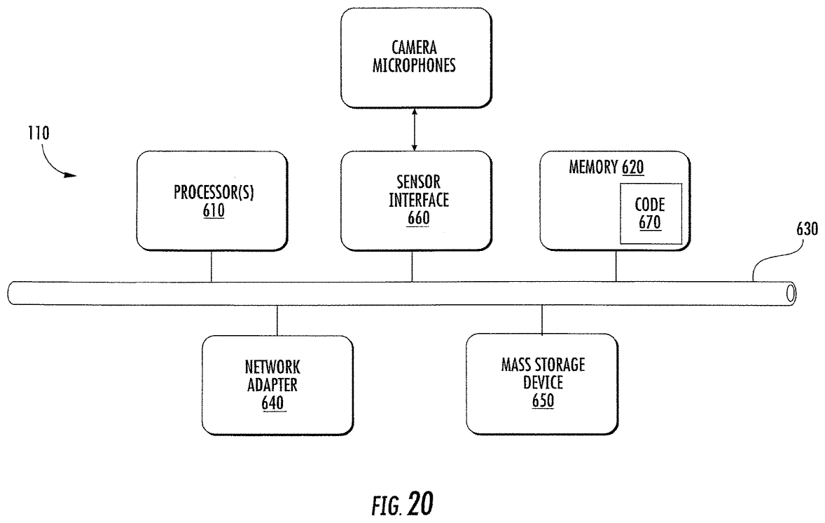

FIG. 19B is a schematic representation of an augmentation function located, for example, in a first earpiece 10A of headphones 110, including a sensor interface 660 as further illustrated in FIG. 20. It will be understood that the sensor interface can be provided as part of the processor shown in the figures herein. According to FIG. 19B, the sensors 5A-5D are coupled to the sensor interface 660 which can operate the sensors 5A-5D to determine positional data for the headphones 110 with six DOF. As illustrated in FIG. 19B, the sensors 5A-5D may be co-located with the sensor interface 660 in an earpiece of the headphones 110, located on some other portion of the headphones 110 (e.g. in the headband or other earpiece 10B) that is electrically/communicatively coupled to the sensor interface 660, or remote from the headphones 110 and communicatively coupled with the sensor interface 660. In some embodiments, the sensor interface 660 controls the sensors 5A-5D to detect electromagnetic and/or physical signals that can be used to determine the positional data for the headphones. For example, if the sensors 5A-5D are video or still cameras, the sensor interface 660 can control the cameras to capture images of the environment with can be used to determine the position of the headphones based on the location of environmental features detected within the images. In contrast, if the sensors 5A-5D are RFID sensors, the sensor interface 660 can control the RFID sensors to determine the position of the headphones based on triangulation of radio signals. If the sensors 5A-5D are accelerometers, the sensor interface 660 can control the accelerometer sensors to determine the orientation and/or movement of the headphones based on detected movement of the accelerometers. As would be understood by one of skill in the art, other sensors are possible, including combinations of multiple types of sensors to achieve determination of the position and/or other characteristics of the headphones 110 and surrounding environment.

As further illustrated in FIG. 19B, the first earpiece 10A of the headphones 110 may contain an augmentation function. The augmentation function may perform operations configured to augment the operations of the headphones 110. In some embodiments, as discussed herein, the augmentation function may perform operations responsive to a request and/or data provided to the headphones 110 and return a result of the request/data to the requestor. For example, in some embodiments, the augmentation function may be provided a request/data from a separate electronic device. In response to the request/data, the headphones 110 may perform calculations and/or other operations related to the request/data and provide a response to the separate electronic device. In some embodiments, the separate electronic device can use the augmentation function of the headphones 110 to perform calculations and/or operations on the behalf of the separate electronic device 30.

Referring to FIG. 19C, the second earpiece 10B of the headphones 110 may contain other electronics used in the operations of the headphones 110. As illustrated in FIG. 19C, the second earpiece 10B of the headphones 110 may also contain an augmentation function similar to the augmentation function in the first earpiece 10A. That is to say that the headphones 110 may contain an augmentation function in either or both of the earpieces 10A 10B. When a plurality of augmentation functions are provided in the headphones 110, they may operate on a request/data provided by a separate electronic device separately or in coordination with one another. In some embodiments, the one or more augmentation functions may be used to process both requests provided by a separate electronic device as well as operations required by the headphones 110. In other words, the augmentation functions are not limited in only handling external requests, but may also handle operations required for the headphones 110.

FIG. 19C also illustrates that the second earpiece 10B of the headphones 110 may also contain one or more sensors 5C. These sensors 5C can be coupled to the sensor interface 660 in the first earpiece 10A of the headphones 110. As will be understood by one of skill in the art, this coupling can be done via several mechanisms, including but not limited to an electronic connection through the headband of the headphones 110.

One of skill in the art would recognize that the configurations of the earpieces illustrated in FIGS. 19A, 19B and 19C are merely representative and that other configurations of the various circuits can be made without deviating from the inventive concept.

FIG. 20 illustrates a high-level block diagram showing an example architecture of an electronic device, such as a headphones 110, as described herein, and which may implement the operations described above. The headphones 110 includes one or more processors 610 and memory 620 coupled to an interconnect 630. The interconnect 630 may be an abstraction that represents any one or more separate physical buses, point to point connections, or both connected by appropriate bridges, adapters, or controllers. The interconnect 630, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire”.

The processor(s) 610 is/are the central processing unit (CPU) of the headphones 110 and, thus, control the overall operation of the headphones 110. As discussed herein, the one or more processors 610 may be configured to perform an augmentation function, such as those illustrated in FIGS. 19B and 19C. In certain embodiments, the processor(s) 610 accomplish this by executing software or firmware stored in memory 620. The processor(s) 610 may be, or may include, one or more programmable general purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices.

The memory 620 is or includes the main memory of the headphones 110. The memory 620 represents any form of random access memory (RAM), read-only memory (ROM), flash memory, or the like, or a combination of such devices. In use, the memory 620 may contain code 670 containing instructions according to the techniques disclosed herein.

Also connected to the processor(s) 610 through the interconnect 630 are a network adapter 640 and a mass storage device 650. The network adapter 640 provides the headphones 110 with the ability to communicate with remote devices over a network and may be, for example, an Ethernet adapter, a Bluetooth adapter, etc. The network adapter 640 may also provide the headphones 110 with the ability to communicate with other computers. The code 670 stored in memory 620 may be implemented as software and/or firmware to program the processor(s) 610 to carry out actions described above. In certain embodiments, such software or firmware may be initially provided to the headphones 110 by downloading it from a remote system through the headphones 110 (e.g., via network adapter 640).

Also connected to the processor(s) 610 through the interconnect 630 are one or more sensor interface 660. The sensor interface 660 may receive input from one or sensors, such as sensors 5A-5D of FIG. 1. Though illustrated as a single element, the headphones 110 may include multiple sensor interfaces 660. In some embodiments, the sensor interfaces 660 may process sensors of different types. The sensor interface 660 may communicate via the interconnect 630 with the memory 620, the processors 610, the network adapter 540 and/or the mass storage device 650 to store, analyze, and/or communicate the input received by the sensor interface 660 to the headphones 110 or a separate electronic device. As shown, the camera and microphone can be accessed via the interface 660.

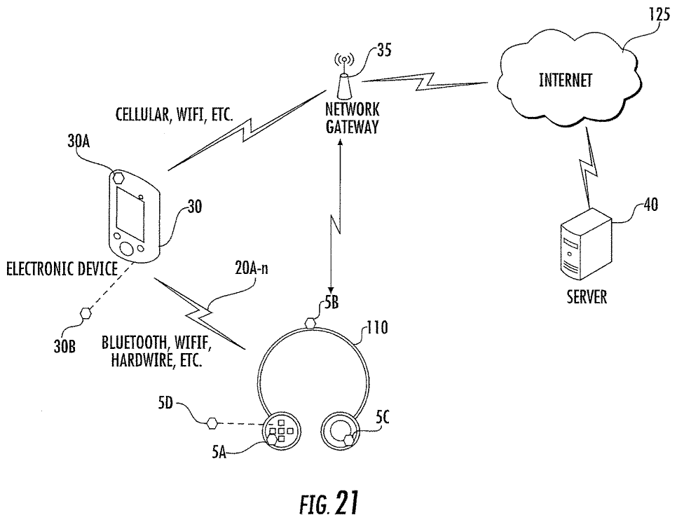

FIG. 21 illustrates an embodiment of a headphones 110 according to the inventive concepts within an operating environment. As illustrated in FIG. 21, the headphones 110 may be communicatively coupled to an electronic device 30 by one or more communication paths 20A-n. The communication paths 20A-n may include, for example, WiFi, USB, IEEE 1394, radio, though the present inventive concepts are not limited thereto. The communication paths 20A-n may be used simultaneously and, in some embodiments, in coordination with one another. The headphones 110 may exchange data and/or requests with the separate electronic device 30.

As illustrated in FIG. 20 and discussed herein, the headphones 110 may be communicatively coupled to one or more sensors 5A-5D. The sensors 5A-5D may be integral to the headphones 110, attached to the headphones 110, or separate from the headphones 110. Similarly, the separate electronic device 30 may be communicatively coupled to the separate electronic device 30, such as sensors 30A-B illustrated in FIG. 20. The sensors 30A-30B may be integral to the electronic device 30, attached to the electronic device 30, or separate from the electronic device 30. As discussed herein, the electronic device 30 and the headphones 110 may share input received from the sensors 5A-5D and 30A-30B to determine a position of a user of the electronic device 30 and the headphones 110.

The electronic device 30 may be in further communication with an external server 40 through a network 125. In some embodiments, the network 125 may be a large network such as the global network more commonly known as the Internet. The electronic device 30 may be connected to the network 125 through intermediate gateways such as the network gateway 35. The electronic device may be connected to the network gateway through various means. For example, the network gateway 35 may be a radio-based telecommunication gateway, such as a base station, and the electronic device 30 may communicate with the network gateway 35 via radio communication such as that commonly used in cellular telephone networks. In some embodiments, the network gateway 35 may be network access point, and the electronic device 30 may communicate with the network gateway 35 via wireless network (“WiFi”). The network gateway 35 may further communicate with the network 125 via a communication method that is similar or different than the one used between the electronic device 30 and the network gateway 35. The communication paths described herein are not intended to be limiting. One of skill in the art will recognize that there are multiple technologies which can be used for connectivity between the electronic device 30 and the server 40 without deviating from the present inventive concepts. In some embodiments, the headphones 110 can access the network gateway 35 directly.

The electronic device 30 may communicate with the server to exchange information, data, and or requests. In some embodiments, the electronic device 30 may share data provided by the headphones 110 with the server 40. In some embodiments, as discussed further herein, the electronic device 30 may retrieve instructions and/or data from the server 40 which may be sent to the headphones 110 for offloading and/or augmentation. In some embodiments, the electronic device 30 may provide requests/data to the headphones 110 for operation thereon, and resulting data provided by the headphones 110 responsive to the requests/data may be further sent from the electronic device 30 to the server 40. In some embodiments, the data provided by the headphones 110 to the electronic device 30 may be combined with data determined by the electronic device 30, such as sensor input from sensors 30A-30B, before being provided to the server 40.

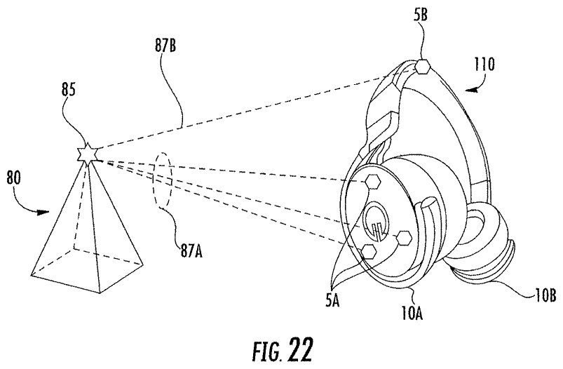

FIG. 22 is a schematic representation of the headphones 110 including the plurality of cameras 5A-5B used to determine positional data in an environment that includes a feature 80, with six DOF in some embodiments. According to FIG. 22, the feature 80 can be at a fixed and/or known location in the environment that is visible to some or each of the sensors 5A-5B. The sensor interface 660 can control the sensors 5A-5B to capture data, for example images (or video) from a sensor that is a camera that depicts the different perspectives 87A-87B of the feature 80 from the respective sensors 5A-5B, respectively. The different perspectives can be used by the sensor interface 660 to determine positional data of the headphones 110. For example, three sensors, such as sensors 5A, may triangulate a position of the feature 80 by analyzing data from three views 87A of the feature 80. As further shown in FIG. 22, the feature 80 can further include a marker 85 which may further assist the sensor interface 660 in locating the feature 80 as well as in determining the positional data.

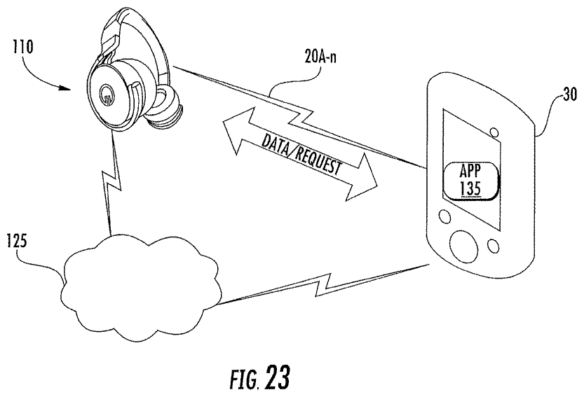

FIG. 23 is a schematic representation of operations between the headphones 110 and a separate electronic device 30 to determine positional data for the headphones as part of an immersive experience provided by the separate electronic device 30. As illustrated in FIG. 23, the headphones 110 may be connected to the separate electronic device 30 by one or more communication channels 20A-n. For example, the headphones 110 may be connected to the separate electronic device 30 by Bluetooth, WiFi, NFC, and/or USB, but the present inventive concept is not limited thereto. In some embodiments, a plurality of the communication channels 20A-n may be used simultaneously. According to FIG. 23, the separate electronic device 30 may transmit requests, via, over the communication channels 20A-n by, for example, an application programming interface (API) for the headphones 110, to the headphones 110 for positional data within the environment with six DOF. The request may include additional data to assist with performing the request. The requests can be received by the augmentation function, which can operate the sensors to generate the requested positional data or other requested service. The generated positional data can then be transmitted to the separate electronic device 30 for use, for example, in generating a display on the separate electronic device 30 as part of the immersive application provided to the user. Accordingly, the separate electronic device 30 may utilize the augmentation function and sensors 5A-5D in the headphones 110 to determine a position of the user head, for example, so that the display may be more satisfying to user. Moreover, this may be provided while also relieving the separate electronic device 30 from determining the positional data.

In still further embodiments, the separate electronic device 30 may have its own sensors and provide a portion of the positional data (such as GPS data and orientation data for the device via an associated accelerometer) and therefore request supplemental positional data from the headphones 110. In such embodiments, the separate electronic device 30 may transmit the requests for supplemental positional data which, when returned by the headphones 110, can be combined with the portion of the positional data provided by the additional sensors of the separate electronic device 30. The separate electronic device 30 may therefore provide an improved immersive experience, (such as a VR or AR immersive experience).

In some embodiments, the separate electronic device 30 may provide the portion of the positional data (such as GPS data and orientation data for the device 30 via an associated accelerometer) from the sensors of the separate electronic device 30 to the headphones 110. In such embodiments, the separate electronic device 30 may transmit the requests for the headphones 110 to determine a position based on the portion of the positional data provided by the separate electronic device 30 and the positional data determined by the headphones 110. The headphones 110 may then provide the absolute and/or relative position back to the separate electronic device 30. The separate electronic device 30 may therefore provide an experience with improved performance, as certain calculations are offloaded to the headphones 110.

This approach can allow for distribution of computational tasks between the electronic device 30 and the headphones 110. This could range from a simple offloading of selected tasks to the headphones 110, to hosting of an application on the headphones 110 that is accessed via a user interface in the electronic device 30.

In still further embodiments, the separate electronic device 30 may use the augmentation function of the headphones 110 to perform text-to-audio translation (i.e. generate spoken audio corresponding to provided text). In such embodiments, the separate electronic device 30 may transmit text data in addition to the request to the augmentation function as part of an electronic book reader application. In operation, the text data can be received by the augmentation function for conversion to audio for listening by the user through the earpieces of the headphones 110. For example, the user may select an option in the electronic book reader application to play audio output that corresponds to the written text of an electronic book. The text data is transmitted to the augmentation function for conversion to audio, which therefore relieves the electronic book reader application from converting the text to audio. Still further, the data transmitted to the headphones 110 may designate a characteristic of the audio play back, such as an accent, gender, or identity of the audio (such as voice characteristic associated with a celebrity). In some embodiments, the characteristics may be stored with the headphones 110, such that the user of the headphones 110 can customize their experience in a way that is persistent regardless of the device providing the text.

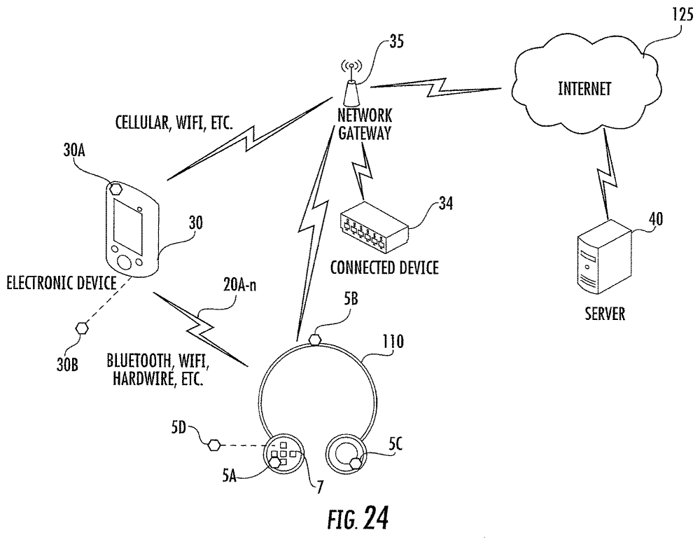

In still further embodiments according to the invention, the headphones 110 can be controlled using applications provided on the mobile device 130 or embedded in the headphones 110 itself via an SDK. FIG. 24 illustrates an embodiment of the headphones 110 according to the inventive concepts within an operating environment. As illustrated in FIG. 24, the headphones 110 may be communicatively coupled to an electronic device 30 (sometimes referred to as a mobile device 130) by one or more communication paths 20A-n. The communication paths 20A-n may include, for example, WiFi, USB, IEEE 1394, radio, though the present inventive concepts are not limited thereto. The communication paths 20A-n may be used simultaneously and, in some embodiments, in coordination with one another. The headphones 110 may exchange data and/or requests with the separate electronic device 30.

As illustrated in FIG. 24 and discussed herein, the headphones 110 may be communicatively coupled to one or more sensors 5A-5D. The sensors 5A-5D may be integral to the headphones 110, attached to the headphones 110, or separate from the headphones 110. Similarly, the separate electronic device 30 may be communicatively coupled to the separate electronic device 30, such as sensors 30A-B illustrated in FIG. 24. The sensors 30A-30B may be integral to the electronic device 30, attached to the electronic device 30, or separate from the electronic device 30.

The electronic device 30 may be in further communication with an external server 40 through a network 125. In some embodiments, the network 125 may be a large network such as the global network more commonly known as the Internet. The electronic device 30 may be connected to the network 123 through intermediate gateways such as the network gateway 35. The electronic device may be connected to the network gateway through various means. For example, the network gateway 35 may be a radio-based telecommunication gateway, such as a base station, and the electronic device 30 may communicate with the network gateway 35 via radio communication such as that commonly used in cellular telephone networks. In some embodiments, the network gateway 35 may be network access point, and the electronic device 30 may communicate with the network gateway 35 via wireless network (“WiFi”). The network gateway 35 may further communicate with the network 125 via a communication method that is similar or different than the one used between the electronic device 30 and the network gateway 35. The communication paths described herein are not intended to be limiting. One of skill in the art will recognize that there are multiple technologies which can be used for connectivity between the electronic device 30 and the server 40 without deviating from the present inventive concepts.

The electronic device 30 may communicate with the server to exchange information, data, and or requests. In some embodiments, the electronic device 30 may share data provided by the headphones 110 with the server 40. In some embodiments, as discussed further herein, the electronic device 30 may retrieve instructions and/or data from the server 40 which may be sent to the headphones 110 for offloading and/or augmentation. In some embodiments, the electronic device 30 may provide requests/data to the headphones 110 for operation thereon, and resulting data provided by the headphones 110 responsive to the requests/data may be further sent from the electronic device 30 to the server 40. In some embodiments, the data provided by the headphones 110 to the electronic device 30 may be combined with data determined by the electronic device 30, such as sensor input from sensors 30A-30B, before being provided to the server 40.

In some embodiments, the sensors 5A-5D and 30A-30B may be still cameras, video cameras, microphones, and/or position detectors. The headphones 110 may also have operational controls 7 which can be transmitted to the electronic device 30. The operational controls 7 may interact with applications running on the electronic device 30 so as to control operations of the headphones 110.

In some embodiments, the electronic device 30 may be communicatively coupled to a connected device 34. The connected device can be any connected device that supports an associated app running in an operating environment of the electronic device 30. In some embodiments, one or more of the sensors 5A-5D and/or 30A-30B may be associated with the connected device 34.

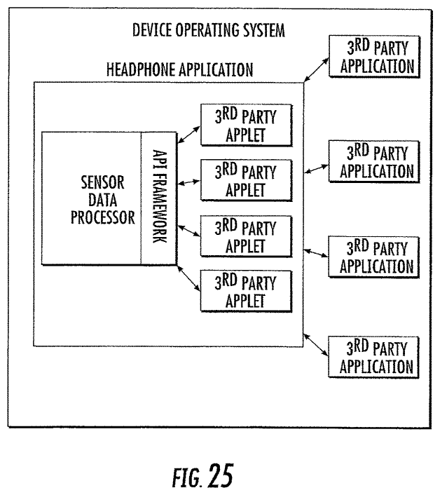

FIG. 25 illustrates an embodiment for a cross-platform application programming interface for connected audio devices. As illustrated in FIG. 25, the electronic device 30 may run a device operating system. In some embodiments, the device operating system may be a portable device operating system such as iOS or Android.

Within the device operating system, a headphone application may execute. The headphone application may be communicatively coupled to the headphones 110 via the electronic device 30. Though illustrated as headphones 110 and headphone application within the figures, it will be understood that the present inventive concepts may apply to any connected wearable device.

Within the operating environment of the headphone application, there may be a sensor data processor. The sensor data processor may communicate with sensors on the headphones 110 and/or the connected device 34. The sensor data processor may operate to provide data from the sensors to third party applications. For example, the sensor data processor may provide a video stream from a camera coupled to the headphones 110 to a third party application for further processing by the third party application (e.g. Facebook Live).

As illustrated in FIG. 25, in an embodiment of the present inventive concepts, the integration with the third party applications may be accomplished via an API framework coupled to the sensor data processor. The third party applications may provide respective third party applets which are configured to execute within the headphone application. The third party applets may be statically or dynamically linked to the headphone application.

The third party applets may be configured to send and/or receive data from the sensor data processor via the API framework. The API framework may be a complete implementation of all the functions by which data may be exchanged between the third party applets and the sensor data processor. Individual ones of the third party applets may implement some or all of the functions defined within the API framework.

Portions of the API framework may support specific classes of devices and/or device implementations. For example, the API framework may define classes such as an AUDIO device and/or a VIDEO device. Third party applets may implement commands to the generic devices and/or may implement customized commands specific to their implementation.

As illustrated in FIG. 25, the third party applets may, in turn, communicate directly to their respective third party applications. The third party applications may also be executing within the device operating system. In some embodiments, the third party applications may communicate with additional externally connected devices.

By integrating with third party applications, the headphone application can provide connective functionality between the headphones 110 and other external devices and/or functions. For example, the visually impaired can use video cameras on the headphones 110 to receive assistance seeing while crossing the road. Video from the video cameras on the headphones 110 may be provided to a third party application on the electronic device 30 to analyze the video stream. The video cameras may act as eyes and then audibly give commands to the wearer of the headphones 110 that it is safe.

In another example, users can look at products in a store and a video camera the headphones 110 will capture video of what the user is seeing and provide the video to a third party application. The third party application may provide targeted sales info based on user preferences, share product info, best price, reviews, and provide the ability to buy now.

In another example, teams can share and collaborate quickly on what they are working on via cameras on the headphones 110 as they look at their computer screens, job sites, fashion shows, medical demonstrations, concerts, etc. The headphones 110 may have built in technology augmented with third party applications to help teams be more efficient collaborating with group chat, networked audio conversation, live audio and video streaming or to the cloud, etc.

The headphones 110 may include a cross platform SDK that allows users to interact with third party applications that include artificial intelligence platforms, such as, for example, Ski, Cortana, Google Voice, Watson, etc.

In some embodiments, the headphones 110 may be remote updatable and may learn user behavior and continue to enhance user experiences with machine learning and bot integration.

When headphones 110 include still and/or video cameras, users can take pictures or videos of everything they see, not just what they see on a screen of the electronic device 30. The headphones 110 may send the content directly to the electronic device 30, cloud, or through streaming audio and video to external platforms and/or application such as Facebook Live, Youtube Live, Periscope, Snapchat, etc.

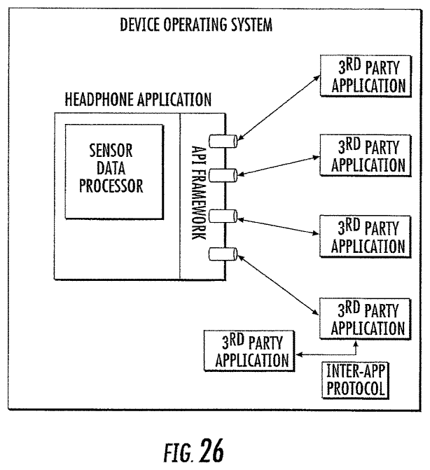

FIG. 26 illustrates another embodiment for a cross-platform application programming interface for connected audio devices.

The embodiments of FIG. 26 are similar to those illustrated in FIG. 25 in that they include a Sensor Data Processor and API framework within a headphone application executing in a device operating system on the electronic device 30.

However, in the embodiment illustrated in FIG. 26, the third party applications may communicate directly with the API framework without requiring the presence of third-party applets within the headphone application. In other words, the third party applications can dynamically access functionality of the API framework without a pre-existing third party applet. For example, the API framework may be provided as a client-server framework handling requests sent from the third party applications.

As illustrated in FIG. 26, the headphone application may recognize the existence of third party applications within the device operating system which do not have a current connection to the headphone application. In some embodiments, the unconnected third party application may represent a newly-added connected device. Responsive to this detection, the headphone application may initiate communication with the third party application and/or prompt the user to perform actions to integrate the third party application. The communication with the third party application may take place over the API framework.

In will be understood that communication between the headphone application and respective ones of the third party applications may be uni-direction or bi-directional, and may be initiated by the headphone application or the third party application.

It will be understood by one of skill in the art that the embodiments of FIGS. 25 and 26 may be combined into an embodiment which utilizes the client-server framework described with respect to FIG. 26 as well as the statically/dynamically linked third party applets of FIG. 25.

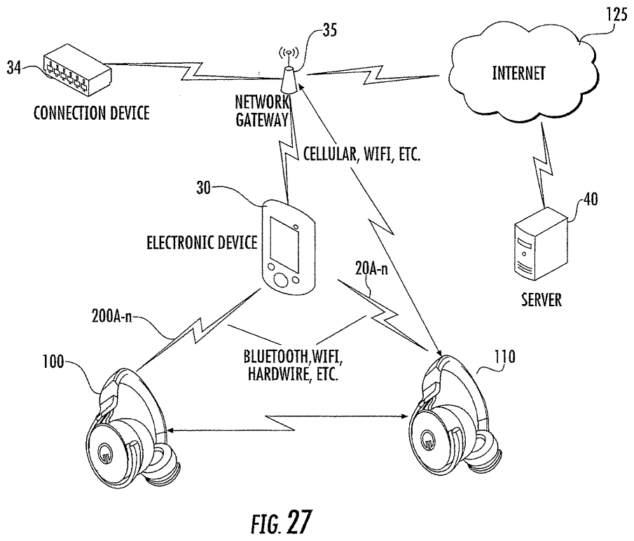

FIG. 27 illustrates an embodiment of a smart remote control 100 according to the present inventive concepts within an operating environment that may be utilized with the headphones 110 as described herein. It will be understood that the inputs provided by the headphones 110 as described herein can also provide the functions of the smart remote so that the systems and operations described herein can be carried out without the smart remote 110 but rather only through use of the headphones 110. As illustrated in FIG. 27, the smart remote control 100 may be communicatively coupled to an electronic device 30 by one or more communication paths 200A-n. In some embodiments, the smart remote control 100 may be physically separate from the electronic device 30. The communication paths 200A-n may include, for example, WiFi, USB, IEEE 1394, Bluetooth, Bluetooth Low-Energy, electrical wiring, and/or various forms of radio, though the present inventive concepts are not limited thereto. The communication paths 200A-n may be used simultaneously and, in some embodiments, in coordination with one another. The smart remote control 100 may exchange data and/or requests with the electronic device 30.

As illustrated in FIG. 1, the electronic device 30 may additionally be connected to headphones 10 via communication paths 20A-n. The communication paths 20A-n may include, for example, WiFi, USB, IEEE 1394, Bluetooth, Bluetooth Low-Energy, electrical wiring, and/or various forms of radio, though the present inventive concepts are not limited thereto. The communication paths 20A-n may be used simultaneously and, in some embodiments, in coordination with one another. The headphones 10 may exchange data and/or requests with the electronic device 30.

The electronic device 30 may be in further communication with an external server 40 through a network 125. In some embodiments, the network 125 may be a large network such as the global network more commonly known as the Internet. The electronic device 30 may be connected to the network 125 through intermediate gateways such as the network gateway 35. The electronic device 30 may be connected to the network gateway 35 through various means. For example, the network gateway 35 may be a radio-based telecommunication gateway, such as a base station, and the electronic device 30 may communicate with the network gateway 35 via radio communication such as that commonly used in mobile telephone networks. In some embodiments, the network gateway 35 may be network access point, and the electronic device 30 may communicate with the network gateway 35 via wireless network (“WiFi”). The network gateway 35 may further communicate with the network 125 via a communication method that is similar or different than the one used between the electronic device 30 and the network gateway 35. The communication paths described herein are not intended to be limiting. One of skill in the art will recognize that there are multiple technologies which can be used for connectivity between the electronic device 30 and the server 40 without deviating from the present inventive concepts.

The electronic device 30 may communicate with the server to exchange information, data, and or requests. In some embodiments, the electronic device 30 may share data provided by the smart remote control 100 and/or the headphones 10 with the server 40. In some embodiments, as described further herein, the electronic device 30 may retrieve instructions and/or data from the server 40 responsive to input received from the smart remote control 100.

In some embodiments, the electronic device 30 may be communicatively coupled to a connected device 34. The connected device 34 can be any connected device that supports an associated application running in an operating environment of the electronic device 30. In some embodiments, as described further herein, the electronic device 30 may exchange data and/or control the connected device 34 responsive to input received from the smart remote control 100. Though illustrated as being connected to the connected device 34 through the network gateway 35, this illustration is not intended to be limiting. In some embodiments, the electronic device 30 may directly connect to the connected device 34 via similar communication paths as described with respect to communications paths 200A-n and 20A-n. For example, a path between the electronic device 30 and the connected device 34 may include, for example, WiFi, USB, IEEE 1394, Bluetooth, Bluetooth Low-Energy, electrical wiring, and/or various forms of radio, though the present inventive concepts are not limited thereto.

The communications paths 20A-n may be different communications paths than the communications paths 200A-n. That is to say that, in some embodiments, the electronic device 30 may communicate with the smart remote control 100 via different communication paths than with the headphones 10, the connected device 34, and/or the server 40. In some embodiments, the electronic device 30 may communicate with the smart remote control 100 via substantially similar communication paths as the headphones 10, the connected device 34, and/or the server 40.

In some embodiments, the input received from the smart remote control 100 may be transmitted to the electronic device 30. The input provided by smart remote control 100 may be used to interact with applications running on the electronic device 30 so as to control operations of the headphones 10, the server 40 and/or the connected device 34.

By varying the operation of applications running within an operating environment of the electronic device 30, the smart remote control 100 may be utilized to control devices connected to the electronic device 30, as described herein.

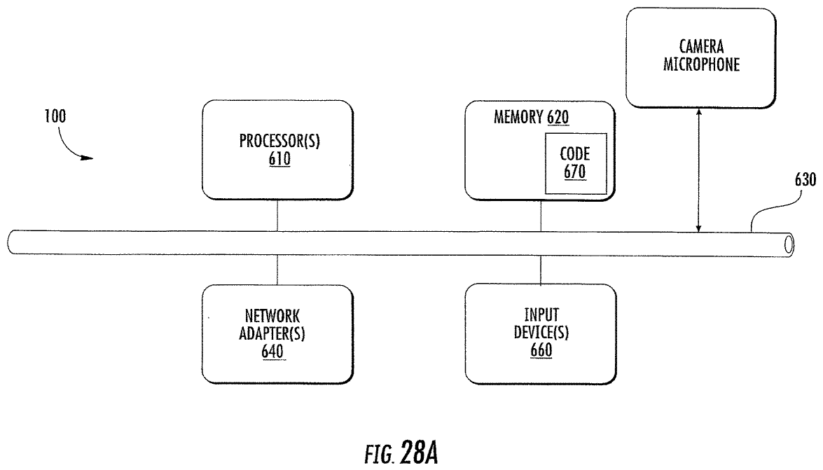

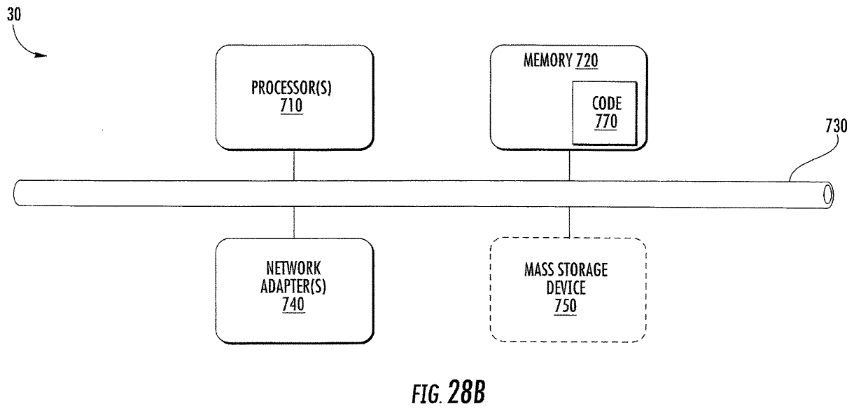

FIG. 28A illustrates a high-level block diagram showing an example architecture of a control device, such as smart remote control 100 as described herein, and which may implement the operations described herein. It will be understood that the headphones 110 can provide the functions of the smart remote control 100 in some embodiments. The smart remote control 100 may include one or more processors 610 and memory 620 coupled to an interconnect 630. The interconnect 630 may be an abstraction that represents any one or more separate physical buses, point to point connections, or both connected by appropriate bridges, adapters, or controllers. The interconnect 630, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire.”

The processor(s) 610 may control the overall operation of the smart remote control 100. As described herein, the one or more processors 610 may be configured to respond to input provided to the smart remote control 100 and transfer that input to the electronic device 30. In certain embodiments, the processor(s) 610 accomplish this by executing software or firmware stored in memory 620. The processor(s) 610 may be, or may include, one or more programmable general purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices.

The memory 620 is or includes the main memory of the smart remote control 100. The memory 620 represents any form of random access memory (RAM), read-only memory (ROM), flash memory, or the like, or a combination of such devices. In use, the memory 620 may contain code 670 containing instructions according to the techniques disclosed herein.

Also, a network adapter 640 may be connected to the processor(s) 610 through the interconnect 630. The network adapter 640 may provide the smart remote control 100 with the ability to communicate with remote devices, including the electronic device 30, over a network and may be, for example, an Ethernet adapter, a Bluetooth adapter, etc. The network adapter 640 may also provide the smart remote control 100 with the ability to communicate with other computers.

The code 670 stored in memory 620 may be implemented as software and/or firmware to program the processor(s) 610 to carry out actions described above. In certain embodiments, such software or firmware may be initially provided to the smart remote control 100 by downloading it from a remote system through the smart remote control 100 (e.g., via network adapter 640). Though referenced as a single network adapter 640, it will be understood that the smart remote control 100 may contain multiple network adapters 640 that may be used to communicate over multiple types of networks.

One or more input device(s) 660 may also be connected to the processor(s) 610 through the interconnect 630. The input device(s) 660 may receive input from one or sensors coupled to the smart remote control 100. For example, the input device(s) 660 may include touch-sensitive sensors and/or buttons. Though illustrated as a single element, the smart remote control 100 may include multiple input devices 660. The input devices(s) 660 may communicate via the interconnect 630 with the memory 620, the processors 610, and/or the network adapter(s) 640 to store, analyze, and/or communicate the input received by the input device(s) 660 to the smart remote control 100, the electronic device 30, and/or another device.

FIG. 28B illustrates a high-level block diagram showing an example architecture of an electronic device, such as electronic device 30, as described herein, and which may implement the operations described herein. The electronic device 30 may include one or more processors 710 and memory 720 coupled to an interconnect 730. The interconnect 730 may be an abstraction that represents any one or more separate physical buses, point to point connections, or both connected by appropriate bridges, adapters, or controllers. The interconnect 730, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire.”

The processor(s) 710 may control the overall operation of the electronic device 30. As described herein, the one or more processors 710 may be configured to receive input provided from the smart remote control 100 and execute operations of a common application programming interface (API) framework responsive to that input. In certain embodiments, the processor(s) 710 accomplish this by executing software or firmware stored in memory 720. The processor(s) 710 may be, or may include, one or more programmable general purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices.

The memory 720 is or includes the main memory of the electronic device 30. The memory 720 represents any form of random access memory (RAM), read-only memory (ROM), flash memory, or the like, or a combination of such devices. In use, the memory 720 may contain code 770 containing instructions according to the techniques disclosed herein.

Also connected to the processor(s) 710 through the interconnect 730 are network adapter(s) 740. The network adapter(s) 740 may provide the electronic device 30 with the ability to communicate with remote devices, including the smart remote control 100, the connected device 34 (see FIG. 1) and/or the server 40 (see FIG. 1), over a network and may include, for example, an Ethernet adapter, a Bluetooth adapter, etc. The network adapter(s) 740 may also provide the electronic device 30 with the ability to communicate with other computers.

The code 770 stored in memory 720 may be implemented as software and/or firmware to program the processor(s) 710 to carry out actions described above. In certain embodiments, such software or firmware may be initially provided to the electronic device 30 by downloading it from a remote system (e.g., via network adapter 740).

Also optionally connected to the processor(s) 710 through the interconnect 730 are one or more mass storage devices 750. The mass storage device 750 may contain the code 770 for loading into the memory 720. The mass storage device 750 may also contain a data repository for storing configuration information related to the operation of the electronic device 30 and/or the smart remote control 100. That is to say that the mass storage device 750 may maintain data used to configure and/or operate the smart remote control 100. This data may be stored in the mass storage device 750 of the electronic device 30 and communicated to the smart remote control 100 via, for example, the network adapter 740.

It will also be understood that the headphones 110 can receive input from the smart remote control 100 for interaction with connected devices using the cross-platform SDK described above.

The remote control application may include a cross platform SDK that allows users to interact with third party applications that include artificial intelligence platforms, such as, for example, Siri, Cortana, Google Voice, Watson, etc. In some embodiments, the remote control application may include a software development kit (SDK) to facilitate development and/or interaction with the API of the remote control application.

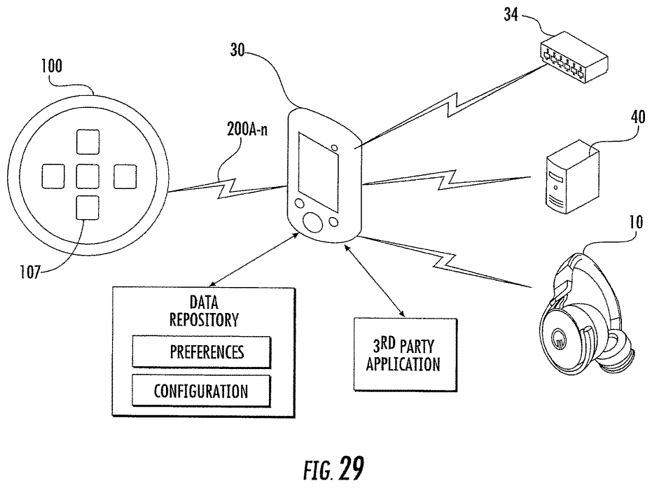

FIG. 29 illustrates another embodiment for a cross-platform API capable of receiving input at the electronic device 30 from the smart remote control 100 for interaction with connected devices.

In some embodiments, third party applications may communicate directly with the API framework without requiring the presence of third-party applets within the remote control application. In other words, the third party applications can dynamically access functionality of the API framework without a pre-existing third party applet. For example, the API framework may be provided as a client-server framework handling requests sent from the third party applications.

The remote control application may recognize the existence of third party applications within the device operating system which do not have a current connection to the remote control application. In some embodiments, the unconnected third party application may represent a newly-added connected device. Responsive to this detection, the remote control application may initiate communication with the third party application and/or prompt the user to perform actions to integrate the third party application. The communication with the third party application may take place over the API framework.

In will be understood that communication between the remote control application and respective ones of the third party applications may be unidirectional or bidirectional, and may be initiated by the remote control application or the third party application.

FIG. 29 illustrates an embodiment in which input provided at the smart remote control 100 is provided to the electronic device 30 for operation of further devices in communication with electronic device 30, such as headphones 10, connected device 34, and/or server 40.

As illustrated in FIG. 29, the smart remote control 100 may have an input sensor 107. In some embodiments, the input sensor 107 may be a touch sensitive control, such as a capacitive and/or resistive sensor. In some embodiments, the input sensor 107 may detect a touch of the user on the input sensor 107. In some embodiments, the input sensor 107 may be a proximity sensor capable of sensing input provided proximate to, but not necessarily touching, the input sensor 107. In some embodiments, the input sensor 107 may be one or more buttons. In some embodiments, the input sensor 107 may be a video camera or microphone when the headphones 110 function as the remote.

In some embodiments, the input sensor 107 may be configured to detect a single touch of a user on or near the input sensor 107. In some embodiments, the input sensor 107 may be configured to detect a “swipe” comprising a sequential series of contacts across or near the input sensor 107. In some embodiments, the input sensor 107 may be configured to detect a series of touches and/or movements that comprise a gesture. Systems and methods for detecting user input comprising touches and gestures are described in U.S. patent application Ser. No. 14/751,952, entitled “Interactive Input Device,” the entire contents of which are included herein by reference.

As further illustrated in FIG. 29, the input received from the input sensor 107 may be provided to the electronic device 30. Upon receipt of the input, the electronic device 30 may determine that the input is to be used to control an additional device. In some embodiments, the additional device may be a connected device 34, an external server 40, and/or headphones 10, though the present inventive concepts are not limited thereto. It will be understood that although only single examples of the connected device 34, an external server 40, and the headphones 10 are illustrated in FIG. 4, the number of devices capable of being accessed by the electronic device 30, is not limited thereto. For example, in some embodiments, the electronic device may be capable of controlling a plurality of connected devices 34 simultaneously in response to input data.

As used herein, the electronic device 30 may control the further devices, such as connected device 34, external server 40, and/or headphones 10 in multiple ways. In some embodiments, the electronic device 30 may process the input data from the input sensor 107 and responsively operate portions of a third party application. In some embodiments, the electronic device 30 may pass on the input data from the input sensor 107 to the third party application, for the third party application to process. In some embodiments, the electronic device 30 may pass on the input data directly to the further device, such as connected device 34, external server 40, and/or headphones 10.

In some embodiments, the electronic device 30 may determine which further device and/or third party application to provide the input based on the contents of a data repository. In some embodiments, the data repository may contain configuration data and preferences data. The electronic device 30 may analyze the input first and then, based on the configuration data and/or preferences data, provide the input to the third party application and/or further device, such as the connected device 34, an external server 40, and/or headphones 10.

Though the third party application may communicate with a further device, such as the connected device 34, an external server 40, and/or headphones 10, it will be understood that not all input data must be communicated to an additional device. In some embodiments, the input data provided from the input sensor 107 may be communicated to a third party application that controls operations of the electronic device 30. For example, the third party application may control a volume of the electronic device 30.

The configuration data may indicate that certain input should be provided to a particular third party application and/or further device based on the type of input provided. For example, the configuration data may indicate that if a particular input is received, it is to be provided to a particular third party application. For example, the configuration data may indicate that a vertical swipe of the input sensor 107 is to advance a track of music currently playing. Upon receipt of such an input from the input sensor 107, the electronic device 30 may indicate to a third party application for playing music that a track-advance command has been received. The third party application for playing music may advance to a different music track and transmit the new music track to the headphones 10.

As another example, the configuration data may indicate that a complex s-shaped gesture received at the input sensor 107 is to share a particular piece of data with an external server 40. Upon receipt of such an input from the input sensor 107, the electronic device 30 may indicate to a third party application for sharing data that a message is to be sent to the external server 40. The third party application for sharing data may transmit the message to the external server 40 and the external server 40 may process the message. The gesture may also be recognized by the video camera on the headphones 110.

As another example, the configuration data may indicate that a gesture shaped as an up-arrow received at the input sensor 107 is to increase a temperature of a connected device 34 comprising a networked thermostat. Upon receipt of such an input from the input sensor 107, the electronic device 30 may indicate to a third party application controlling the connected device 34 that a temperature change is needed. The third party controlling the connected device 34 may transmit an appropriate communication, which may be proprietary to the connected device 34, to increase the current temperature.

The configuration data may also indicate additional ways in which the electronic device 30 may determine which third party application and/or further device is to receive communication in response to the input data from the input sensor 107.

For example, in some embodiments, the third party application and/or device that will receive the communication in response to the input data from the input sensor 107 depends on which external devices are in communication with the electronic device 30. For example, a particular up-arrow gesture may be associated with the initiation of noise cancelling if headphones 10 are detected as being connected to the electronic device 30. If headphones 10 are not detected, the up-arrow gesture may be associated with an increase in temperature for a connected device 34, such as a networked thermostat, if connected device 34 is in communication with the electronic device 30. If neither the headphones 10 nor the connected device 34 is in communication with the electronic device 30, then the up-arrow gesture may be associated with increasing a volume of the electronic device 30. The electronic device 30 may dynamically change what operations are performed responsive to the input data from the input sensor 107 responsive to changing conditions on the electronic device 30.

In some embodiments, the third party application and/or device which receives the communication in response to the input data from the input sensor 107 may depend on which third party applications are currently operating on the electronic device 30 independently of any connected devices. For example, a forward swipe gesture received as input from the input sensor may be provided to a music application to advance a music track if a third party music application is running, and may be provided to a phone application to drop a current call if a call is currently active on the electronic device 30.

In some embodiments, the third party application and/or device which receives the communication in response to the input data from the input sensor 107 may depend on location of the electronic device 30. In some embodiments, the electronic device 30 may include functionality configured to determine the location of the electronic device 30. For example, the electronic device 30 may have a GPS sensor or other circuit capable of determining a current location. The electronic device 30 may use this current location to further differentiate which third party application may receive data corresponding to the input provided from the input sensor 107. For example, if the electronic device 30 determines that the electronic device 30 is currently located at a home of the user of the electronic device 30, the electronic device 30 may determine that a particular gesture received from the input sensor 107 is to be provided to a third party application associated with a connected device 34 including a thermostat. If the electronic device 30 determines that the electronic device 30 is currently located remote from the home of the user of the electronic device 30, the electronic device 30 may determine that the particular gesture received from the input sensor 107 is to be discarded, or, in some embodiments, to be provided to a third party application associated with an external server 40. The external server 40 may be configured to remotely connect to the thermostat at the house of the user of the electronic device 30.

In some embodiments, the third party application and/or device which receives the communication in response to the input data from the input sensor 107 may depend on a determined speed of the electronic device 30. In some embodiments, the electronic device 30 may include functionality configured to determine motion and/or speed of the electronic device 30. For example, the electronic device 30 may have an accelerometer sensor or other circuit capable of determining motion of the electronic device 30. The electronic device 30 may use this determined speed to further differentiate which third party application may receive data corresponding to the input provided from the input sensor 107. In some embodiments, if the electronic device 30 determines that the electronic device 30 is currently moving at a speed greater than a particular threshold, the electronic device 30 may determine that a particular gesture received from the input sensor 107 is to be provided preferentially to a third party application associated with the operation of a vehicle. For example, if moving quickly, a gesture interpreted as an up-arrow may preferentially be provided to a third party application associated with increasing the volume of an automobile sound system. If the electronic device 30 determines that the electronic device 30 is currently moving at a speed less than a particular threshold, the electronic device 30 may determine that the particular gesture received from the input sensor 107 is to be preferentially provided to a third party application associated with operation of the electronic device 30 and/or other connected device. For example, if not moving or moving slowly, the gesture interpreted as an up-arrow may preferentially be provided to a third party application associated with increasing the volume of the electronic device 30 and/or headphones 10 connected to the electronic device 30.

The preference data on the electronic device 30 may indicate that certain input should be provided to a particular third party application and/or further device based on a user and/or system preference. For example, the preference data may indicate that that a certain destination has priority if the electronic device 30 has multiple further devices and/or third party applications to which data associated with the input data from the input sensor 107 may be sent. The preference data may also indicate a particular mapping for a gesture to a particular operation by the electronic device 30. The preference data may, in some embodiments, override the configuration data.

In some embodiments, the preference data may be provided as part of the input data. For example, the input data provided by the user at the smart remote control 100 may include two portions: a first portion that identifies a particular device and/or third party application, and a second portion that identifies additional input to be forwarded to that application. For example, a first motion on an input sensor 107 of the smart remote control 100 may indicate that the next input is to be provided to a texting third party application, and a second motion on the input sensor 107 of the smart remote control 100 may input the particular command, such as the sending of a preformatted text message, to be sent to the texting third party application.

In some embodiments, the preference data may be kept for a particular user. The preference data may be accessed by the electronic device 30 in response to a particular smart remote control 100 and/or an identification of a particular user using the smart remote control 100.

In some embodiments, the electronic device 30 may be capable of managing multiple smart remote controls 100, and preference data may be maintained for each of the smart remote controls 100. The preference data may be based on a particular unique value that is associated with the respective smart remote controls 100 that is passed to the electronic device 30 during communication with the smart remote control 100. For example, this unique value may include a serial number of the smart remote control 100, and/or an address of the smart remote control 100 on one of the communications paths 200A-n (see FIG. 1). In some embodiments, the electronic device 30 may be able to access an RFID associated with the smart remote control 100 to determine a unique identity for the smart remote control 100.

In some embodiments, the smart remote control 100 may have other inputs which allow a specific user to be identified. For example, in some embodiments, the smart remote control 100 may have a fingerprint sensor. The fingerprint sensor may allow a user of the smart remote control 100 to identify themselves to the electronic device 100 and access features of the smart remote control 100. In some embodiments, the electronic device 30 may use a fingerprint retrieved via smart remote control 100 to identify the user of the smart remote control 100 so as to load a particular set of preference data for the user. In some embodiments, the fingerprint sensor of the smart remote control 100 may be used as an additional identification and/or security device for the electronic device 30.

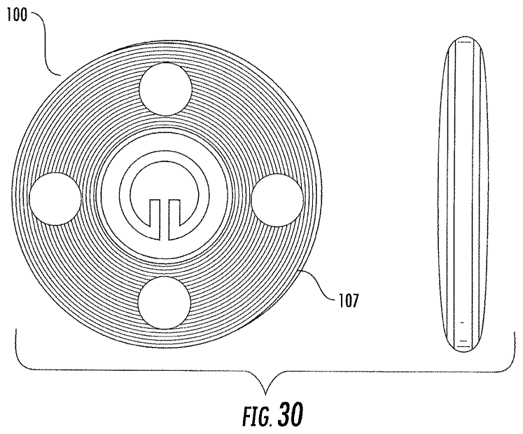

FIGS. 30-34 illustrate example embodiments of a smart remote control 100 according to the present inventive concepts.

As illustrated in FIG. 30, the smart remote control 100 may be embodied as a separate stand-alone device. In some embodiments, the input sensor 107 may be located on one or both sides of the smart remote control 100. The configurations of the input sensor 107 may be different depending on which side of the smart remote control 100 they are received. For example, a particular gesture on a first side of the smart remote control 100 may be interpreted separately and/or differently from the same gesture on a second side of the smart remote control 100.

The smart remote control 100 as illustrated in FIG. 30 may include a battery. The battery may be charged via a wired connection to the smart remote control 100 and/or wirelessly.

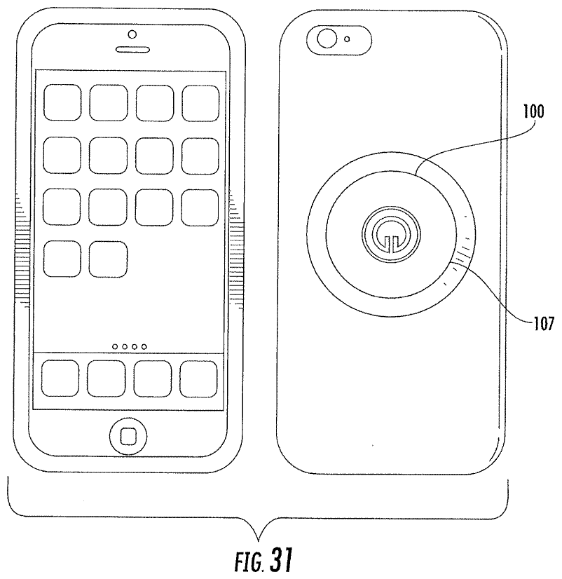

FIG. 31 illustrates an example embodiment of the smart remote control 100 in which the smart remote control 100 is incorporated as part of a phone case. In such embodiments, the electronic device 30 may be the phone contained within the phone case, but the present inventive concepts are not limited thereto. The smart remote control 100 may be coupled to the phone so as to receive power from the phone and/or may have a separate battery. In some embodiments, the battery used to power the smart remote control 100 may provide additional charging for the phone.

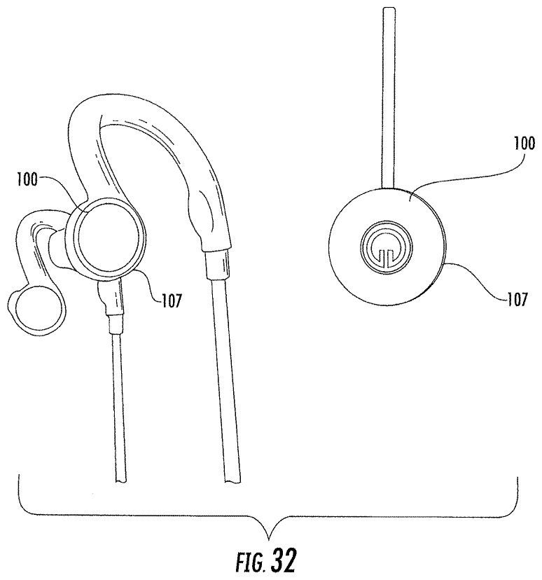

FIG. 32 illustrates an example embodiment of the smart remote control 100 in which the smart remote control 100 is incorporated as a set of earbuds. In such embodiments, the smart remote control 100 may be inline, or otherwise connected with, a wire of the earbuds. In some embodiments, the smart remote control 100 may be integrated into the earbud itself. In such embodiments, the smart remote control 100 may have a separate battery and/or may receive power over the wire of the earbuds. In some embodiments, the smart remote control 100 may automatically communicate with an electronic device 30 to which the earbuds are connected, but the present inventive concepts are not limited thereto. The earbuds may also have all of the functions associated with the headphones 110 including hot keys, biosensors, and all other sensors described herein.

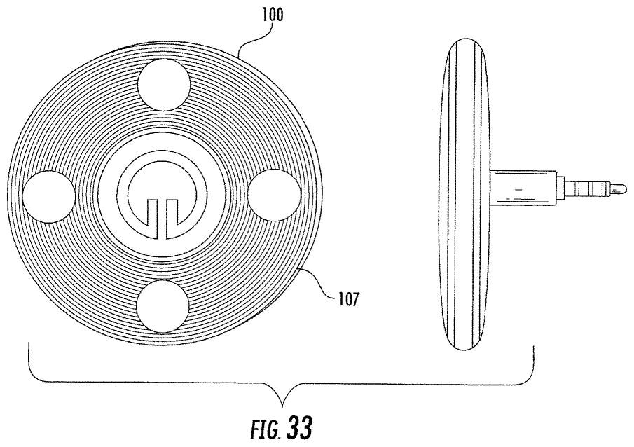

FIG. 33 illustrates an example embodiment of the smart remote control 100 in which the smart remote control 100 is incorporated with an audio jack. In such embodiments, the smart remote control 100 may be configured to be inserted into a standard audio jack, such as a 3.5 mm headphone jack commonly used on some phones, though the present inventive concepts are not limited thereto. In such embodiments, the smart remote control 100 may have a separate battery and/or may receive power over the audio jack. In some embodiments, the smart remote control 100 may automatically communicate with an electronic device 30 to which the earbuds are connected to through the audio jack, but the present inventive concepts are not limited thereto.

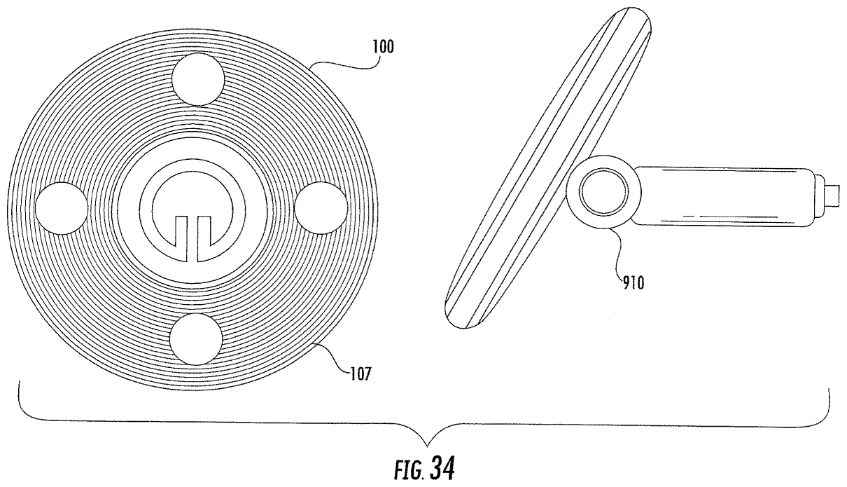

FIG. 34 illustrates an example embodiment of the smart remote control 100 in which the smart remote control 100 is incorporated with a DC power connector. In some embodiments, the DC power connector may be configured to insert into a cigarette lighter receptacle in an automobile. In such embodiments, the smart remote control 100 may have a separate battery and/or may receive power from the DC power connector. In some embodiments, when used in an automobile, the smart remote control 100 may automatically communicate with a nearby electronic device 30, such as a personal phone of a driver of the automobile, to control a sound system of the automobile, but the present inventive concepts are not limited thereto. As illustrated in FIG. 34, the smart remote control 100 may include a pivot point 910 to allow a face of the smart remote control 100 to be tilted for convenient access.

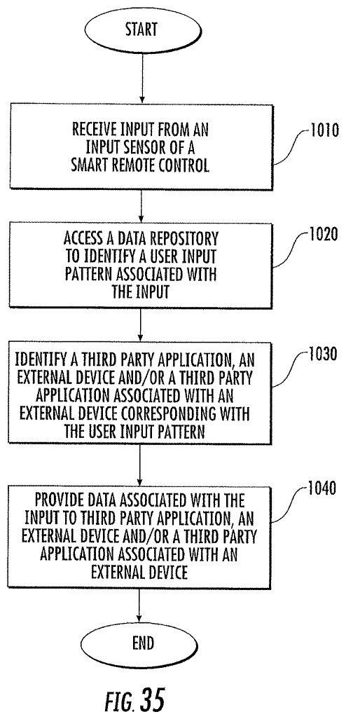

FIG. 35 illustrates an embodiment in which the electronic device 30 may provide input to an external device based on input from a smart remote control 100.

Beginning at operation 1010, the electronic device 30 may receive input from an input sensor 107 of a smart remote control 100. As described herein, this input may be communicated over communications paths 200A-n between the smart remote control 100 and the electronic device 30.

The operations may continue at operation 1020, in which the electronic device 30 accesses a data repository to identify a user input pattern associated with the input received from the input sensor 107. As described herein, the user input pattern may be a gesture performed by a user at the smart remote control 100.

The operations may continue at operation 1030, in which the electronic device 30 identifies a third party application, an external device and/or a third party application associated with an external device that corresponds with the user input pattern. The external device may be, for example, a connected device 34, external server 40, and/or headphone 10, as described herein.

The operations may continue at operation 1040, in which the electronic device 30 provides data associated with the input received from the smart remote control 100 to the third party application, the external device and/or the third party application associated with the external device

In some embodiments according to the inventive concept, the headphones, methods, and systems described herein can be utilized to provide applications configured, for example, to provide particular solutions. Accordingly, the systems devices and methods shown in the figures herein can provide an underlying framework for those solutions. For example in some embodiments according to the inventive concept, the method illustrated for example by FIG. 4 using a companion app to stream live audio/video can provide the basic framework for a particular application some of which is described herein below in greater detail.

It will be understood, however, that many systems and devices can be supported by multiple ones of the embodiments shown in the figures. For example, the same basic operations provided in a particular application enabled by the systems methods and devices described herein may be supported by multiple ones of the figures. Moreover, some flow charts may provide support for particular operations which occur across a network whereas other figures can provide support for the particular device or network employed.

In some embodiments according to the inventive concept, the operations described herein are carried out by a native application that is resident on the headphones 110 running, for example, on a Snap Dragon microprocessor, as shown for example in FIGS. 3 and 10. In still other embodiments according to the inventive concept, the operations can be carried out by an application that is resident on a mobile device, such as a smartphone. In still further embodiments according to the inventive concept, the operations can be carried out by a combination of applications which operate on multiple platforms across the network. In still further embodiments according to the inventive concept, it will be understood that the inputs provided to the headphones 110 can be provided by audio commands via the microphones included on the headphones 110. Accordingly, native applications within the headphones 110 or applications resident elsewhere can be utilized to translate audio commands which can then be executed as part of the embodiments described herein.

In some embodiments according to the inventive concept, the headphones 110 can provide a base platform for implementation of the personal assistant for the user. In such embodiments, the personal assistant can respond to queries regarding the user's calendar, weather, events, etc. For example, in some embodiments according to the inventive concept, the personal assistant implemented by the headphones 110 (or mobile device operating therewith) can determine that the user is scheduled for an upcoming trip including a long air segment. In response, the personal assistant can download a suggested playlist of audio selections for listening during that air segment. Furthermore, the personal assistant can receive feedback from the user regarding the seed ability or users reaction to the playlist. In still further embodiments according to the inventive concept, the personal assistant can be utilized to scheduled requested events, such as doctor's appointment, auto repair appointments, etc. Accordingly, in such implementations, the headphones 110 can operate with remote servers that provide both the users schedule, personal information, or other information utilized to anticipate needs or desires as well as remote servers that are utilized to fetch information associated with events to be supported such as airline schedules, hotel reservations, etc.

In some embodiments according to the inventive concept, the headphones 110 can support an application (such as a preloaded native application configured for VOIP call or message setup) that enables call set up or message set up for a particular applications. For example, in some embodiments according to the inventive concept, the user may speak a command that is a phone call is to be initiated among a group of recipients. In response, the application operating within the headphones 110 or remote can set up the call with the group by accessing users contacts list to determine contact numbers for the individuals including or, in some embodiments according to the inventive concept, those individual identified by a particular group (i.e., such as the engineering group). Accordingly, when the user speaks the command “call engineering group” the headphones 110 can utilize the application operating thereon to set up a call with those members of the engineering team which are identified in the users contact list as well as using the numbers associated with those members. In some embodiments according to the inventive concept, the same basic functionality can be provided through messaging rather than voice. Still further, those calls may be logged, recorded, and indexed for content. In some embodiments, the calls can be translated to other languages preferred by particular group members.

In some embodiments according to the inventive concept, the headphones 110 utilizing the native application or remotely supported application sensors can be included in the headphones 110 to monitor the users biometric functions (such as heart rate, blood pressure, oxygen levels, movements, etc.). Still further, the same basic operations can be provided via in-ear headphones rather than over the ear or on the ear headphones. In such embodiments, the in-ear headphones can support the same basic functions (such as hot keys, capacitive touch surfaces, biometric sensors described above, etc.). Other sensors may also be utilized. In some embodiments according to the inventive concept, the earbuds/the headphones 110 can include a native application that provides meditation coaching to the user or analytics that record movements or activities on the part of the user and can then be fed back to the user for use later.

In some embodiments according to the inventive concept, the headphones 110 may support an education environment wherein users/students may access remote applications or imbedded applications such as Rosetta Stone wherein the user can learn a foreign language through voice interaction through the headphones 110 and a remote server. Accordingly, when the user is learning a foreign language, the foreign language prompts or lessons can be provided to the user via the headphones 110 from the remote server whereupon the user may provide audio responses during the lesson which are then forwarded either to the native application imbedded in the headphones 110 or the remote server that supports the application. In some embodiments, the camera can be used to live stream a user undergoing reading instruction where a remote teacher uses the streamed video to monitor the student's progress and correct student where needed.

In some embodiments according to the inventive concept, these same arrangements may be utilized to support a group of students which are learning collaboratively. In such embodiments, individual users may be able to interact with selected other individual users to collaborate on particular points of interest in a lesson. Still further, a teacher or instructor may be able to selectively interact with only a group of students that need particular assistance whereas the remainder of the students may proceed with the lesson. Accordingly, such implementations may be provided across a plurality of headphones in communication with the server and each conducting communications to/from the headphones 110 to provide the audio instruction as part of the educational environment as well as the audio responses from the students. Further, inputs may also be provided via the touch sensitive surface of the headphones 110 as well as via voice input. In some embodiments according to the inventive concept, the educational environment may also include the provisioning of live streaming video from students (such as during a lab or experiment) so that the instructor can monitor their progress or correct for misunderstandings during the lesson. In some embodiments according to the inventive concept, the live streaming can be stored for future reference by the instructor or by the students who wish to review the lessons after the fact.

In some embodiments according to the inventive concept, the headphones 110 can be utilized to provide a remote presence by which users can act as local observers for remote actors who can provide guidance (via audio) to the local user to wearing the headphones 110. For example, in some embodiments according to the inventive concept, live video streaming can be provided to the remote actor whereupon audio instructions can be provided to the local user who could then act on instructions given by the remote actor. For example, in a telemedicine application, the local user may act under the instructions of a remote physician to examine certain aspects of a patient's physiology or symptoms. It will also be understood that a native application can be used to process an image (including a symptomatic area) and relevant data bases or libraries are accessed to match the image to a known condition. Still further, the video streamed may be zoomed using voice or touch input using the capacitive touch surface.

Accordingly, in some embodiments of the invention the headphones 110 can be linked to an artificial intelligence that is configured to associate particular visual symptoms with particular conditions which may be suggested to the wearer remotely. Upon hearing the suggestion of the particular condition, the user may be directed to aim the cameras at a different portion of the body to gather additional information or an audio signal is played to the user indicating the likely condition (e.g. chicken pox) which may in turn generate a message from the headphones 110 to a telemedicine registered doctor having a specialization in the particular condition.

In some embodiments according to the inventive concept, remote experts can guide local users who are tasked with a procedure or assembly that would otherwise be error prone or too lengthy without the guidance of the remote actor. For example, in some embodiments according to the inventive concept, a remote technician may assist a local user in the setup of a computer system or the resolution of a software issue.

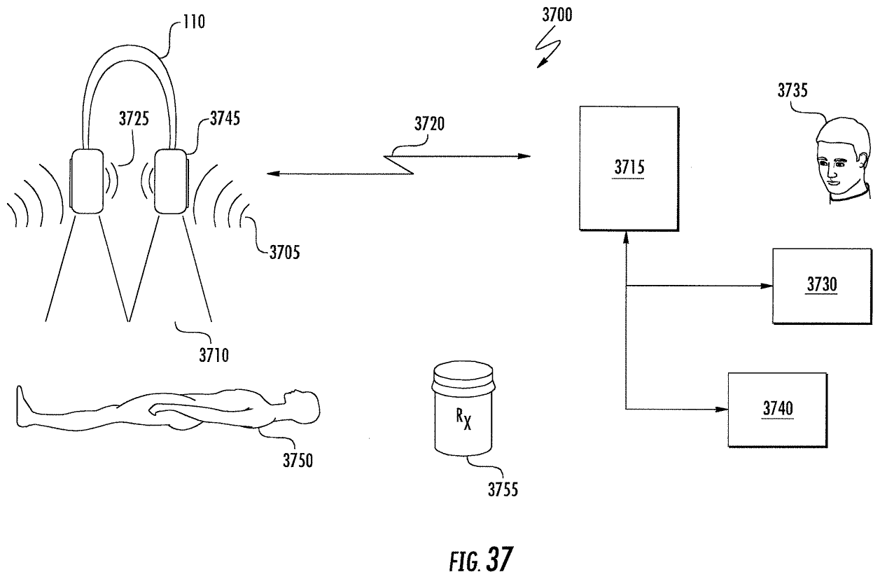

FIG. 37 is a schematic representation of a telemedicine system 3700 including the Headphones 110 as described herein. FIG. 37 also illustrates that the Headphones 110 are wirelessly coupled to a system 3715 which can provide an artificial intelligence service configured to process images and/or audio provided by the Headphones 110 to determine possible diagnosis of a subject 3750 based on the image data and/audio data in some embodiments according to the invention. It will be understood that the Headphones 110 can include a plurality of video cameras each of which can sample and generate a live video stream that can be provided to the system 3715 via a wireless connection 3720. It will be also understood that the Headphones 110 can include a plurality of microphones that are configured to receive audio signals 3705 which then can be streamed to the system 3715 via the wireless connection 3720. The wireless connection 3720 can be any type of wireless interface described herein.

The Headphones 110 can also include internal speakers that generate audio 3725 for the wearer. In operation, the Headphones 110 can be worn by a local user to support operation in the telemedicine system 3700 in some embodiments according to the invention. For example, the local user can be a third party that is assisting with an examination of the subject 3750 and acting under the direction of a remote user 3735, such as a doctor or other medical professional. In other embodiments according to the invention, the local user can be a doctor that is examining the subject 3750 or performing surgery. For example, in performing an examination of the subject 3750, the doctor may utilize the Headphones 110 to sample live video (or static images) as well as audio 3705 for storage on a remote system 3740, such as a system that would store medical records or insurance data. In still other embodiments according to the invention, the doctor may utilize the headphones 110 to record a diagnosis derived by the doctor which in turn is transmitted to the system 3740 for storage thereon. In some embodiments, the live video (or static images) as well as audio 3705 can be generated during a surgical procedure, which can be stored.

In other embodiments according to the invention, the local user can be a third party that employs the Headphones 110 under the instruction of the remote user 3735 by listening to the audio signals 3725 that are provided by the remote user 3735. For example, in some embodiments according to the invention, the remote user 3735 may instruct the local user to pan in a certain direction so that a particular part of the anatomy is recorded by the video 3710. In still other embodiments according to the invention, the remote user of 3735 can relay questions to the local user that can be repeated to the subject 3750. The responses from the subject 3750 can be relayed to the remote user 3735 via the audio signals 3705 or provided directly via the microphones. Still further, the local user can provide additional commentary on the subject 3750 while operating under the control of the remote user 3735. In such embodiments according to the invention, all of the data provided via the Headphones 110 can be recoded on the system 3740. Still further, the data may also be provided to a system 3730 accessed by the remote user 3735. The remote user 3735 may utilize the system 3730 to assist in a diagnosis based on the data provided by the Headphones 110. In still other embodiments according to the invention, each of the systems shown in FIG. 37 can be interfaced to the Headphones 110 via an SDK or API as described herein. It will be also understood that the system 3740 can include a portion thereof or a front end that provides translation of audio data to text for storage by the system 3740.

In still further embodiments according to the invention, the local user can be the subject 3750 who can perform a self-exam using the Headphones 110. In such embodiments according to the invention, the subject 3750 may act as the third party described above to provide information to the remote user 3735 and may operate under the instructions thereof via the audio 3725 to, for example, direct the video 3710 to the area of interest and to provide audio feedback 3705 to the remote user 3735 or system 3715.

In some embodiments according to the invention, the system 3715 can provide a diagnosis of the subject 3750 based on the audio and/or video provided from the Headphones 110. For example, the system 3715 may access a plurality of medial databases and/or medical experts systems storing repositories of images and symptoms associated with particular conditions. The system 3715 can utilize those remote systems to determine a likely diagnosis for the condition observed by the Headphones 110. In still further embodiments according to the invention, the system 3715 can operate in an autonomous mode to provide feedback to the local user such as a likely diagnosis associated with the symptoms presented by the video and/or audio. For example, in some embodiments according to the invention, the system 3715 may receive audio and/or video from the Headphones 110 depicting the condition of the subject 3750 whereupon the system 3715 accesses the remote systems to determine the most likely diagnosis for the symptoms presented.

Once the most likely diagnosis is determined by the system 3715, the audio feedback can be provided to the Headphones 110 so that the local user can determine the best course of action based on the feedback provided by the system 3715. For example, if the feedback from the system 3715 is a particular condition, the system 3715 may present several options to the local user on how to proceed, such as route a call to a doctor having a specialization in the area most closely associated with the probable diagnosis, take further steps to investigate the condition, call local emergency services, or a request for further information regarding the subject 3750.

It will also be understood that the system 3715 can include a component which provides translation of audio to/from the Headphones 110 such that the existing 3715 can support a local user regardless of the native language spoken by the local user. Accordingly, when the local user speaks to the system 3715, the system recognizes the native language of the local user and translates audio information to the Headphones 110 to the native language of the local user.

In some embodiments according to the invention, the video 3710 can be used to recognize particular prescription medication 3755 that may be associated with the subject 3750. When the prescription medication 3755 is sampled by the video 3710 a video image (or a static image) can be provided to the system 3715 whereupon on the remote systems can be accessed to determine possible side effects of the prescription medication 3755 which may be associated with the condition of the subject 3750. Still further, if multiple prescription medication 3755 are associated with the subject 3750, the system 3715 can determine whether a potential interaction has occurred between the prescription medications 3755 (based on, for example, the live video). The determination can be provided to the local user by the audio 3725. Still further, the system 3715 may provide the local user with addition instructions to gather information on the prescription medications 3755 or to ask the subject 3750 for additional information regarding the usage of the prescription medications 3755.

In still further embodiments according to the invention, the remote user 3735 may include a plurality of remote users 3735 among which are specialists having a particular background associated with particular conditions which may be exhibited by the subject 3750. Accordingly, when a particular remote user 3735 determines that the condition of the subject 3750 may be associated with a particular condition, the remote user 3735 may refer the treatment of the subject 3750 to one of the other remote users 3735 having a specialization in the area most likely associated with the condition of the subject 3750. Still further, the local user 3735 may ask for a second opinion from another of the remote users 3735.

In still further embodiments according to the invention, the Headphones 110 may be utilized by visually impaired to provide assistance in providing self-examination/diagnosis in combination with the system 3715 providing artificial intelligence services. For example, in some embodiments according to the invention, a visually impaired user may wear the Headphones 110 and examine themselves in a mirror to sample the video 3710 associated with a particular condition. Still further, the audio signals 3725 can be provided by the system 3715 to prompt the local user (i.e. the visually impaired local user) to pan the video 3710 in the direction of the affected area that the system 3715 wishes to sample. The audio signals 3725 can therefore be tightly coupled to provide feedback to the local user 110 so that the video 3710 adequately samples the affected area. In still further embodiments according to the invention, the Headphones 110 can include local sensors that are configured to determine the status of the local user wearing the Headphones 110 (such as heart rate, SP02, etc.).

In still further embodiments according to the invention, the Headphones 110 can produce the audio 3725 either locally or under the control of the remote system 3715 to provide a customized hearing test for the local user 110 under the supervision of the remote user 3735 or the system 3715 in an autonomous mode. In response, the local user can provide audio feedback to the system 3715 or the remote user 3735 to determine the results of the hearing test.

In still further embodiments according to the invention, the doctor acting as the local user can record a surgical procedure using the video 3710 and/or the audio 3705 which is then stored in the remote system 3740. In still further embodiments according to the invention, video, image data, and/or audio data can be regularly sampled and stored on the remote system 3740 for comparison to one another over a longer period of time. Accordingly, the local user 110 may periodically do a self-examination to record the same areas of the body which are then stored on the remote system 3740 for later access. After a particular period of time when enough data has been sampled, the system 3715 may provide a diagnosis based on progressive changes exhibited by the stored data. In still further embodiments according to the invention, the system 3740 can be accessed by remote operators to transcribe audio data recorded by doctors acting as the local user. For example, during an examination of the subject 3750, the doctor may dictate the impressions derived from the examination which are stored on the system 3740 and later transcribed by the remote operators.

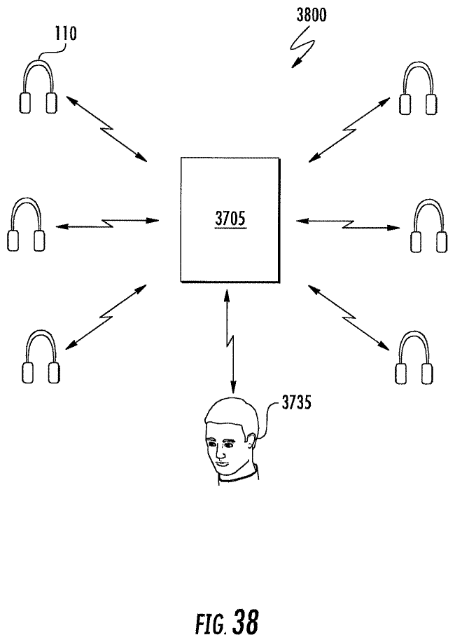

FIG. 38 is a schematic representation of a plurality of headphones 110 operatively coupled to a symptom aggregation system 3805 in some embodiments according to the invention. As shown in FIG. 38, the system 3805 can receive and send information to each of a plurality of headphones 110 which may be distributed among a wide geographic area. For example, in some embodiments according to the invention, the headphones 110 are operatively coupled to the system 3805 by the internet and each may reside in a different geographic region including different countries or portions of the world. It will be further understood that each of the headphones 110 can be configured to provide live video and/or audio streaming to the system 3805. Still further, in some embodiments according to the invention, the system 3805 may enable live streaming of the headphones remotely. In other words, the system 3805 may determine to activate live streaming of selective ones of the headphones based on data received from the headphones.

In operation, the system 3805 can monitor video/audio stream from the headphones 110 the occurrence of symptoms in the general population over a wide geographic area. For example, in some embodiments according to the invention, remote users may wear the headphones 110 in day to day activity where the system 3805 receives live video and/or audio from the headphones and analyzes that video and/or audio to detect symptoms which may be associated with a particular condition, and especially conditions which are communicative. For example, in some embodiments according to the invention, the system 3800 may be utilized to monitor the occurrence and spread of contagious diseases over a wide geographical region. Moreover, the live streaming from the headphones can be used for early detection of the outbreak of certain conditions which may be geographically limited. For example, if the headphones 110A and 110B are located within a close geographic proximity to one another the system 3805 may analyze their respective live streams from headphones 110A and 110B to detect whether members of the population in that region are exhibiting symptoms of a particular condition. Once a condition is recognized, the system 3805 can notify operators or supervisory system 3735 to take remedial action. For example, in some embodiments according to the invention, the supervisory system 3735 may activate the headphones 110A and 110B to provide more constant live streaming from the headphones in that region (i.e., and not limited to simply headphones 110A and 110B). Still further, the supervisory system 3735 may control the system 3805 to enable the live streaming from the headphones in that region more frequently.

Once the supervisory system 3735 or the system 3805 determines that an outbreak may have occurred in a particular region, warning indicators can be provided to the headphones 110 in their respective geographic region. For example, once the system 3805 determines that an outbreak may have occurred in the region in which headphones 110A and 110 B are being used, the system 3805 can dispatch audio warnings to the headphones 110A and 110B as well as any other headphones in the geographic region to take particular steps to avoid exposure or to receive treatment.

Still further, in some embodiments according to the invention the headphones 110A can include sensors such as heart rate sensors, SPO2 sensors, temperature sensors, etc. that monitor physical parameters of the wearer which can then be forwarded to the system 3805 and supervisory system 3735 for further processing in response to a suspected outbreak. It will be also understood that the system 3805 can be coupled to the systems 3715, 3730, and 3740 shown in FIG. 37 so that the video and/or audio collected from the headphones 100 in FIG. 38 can be archived and subject to processing by the artificial intelligence system 3715. And so further embodiments according to the invention, the functionality of the artificial intelligence system 3715 and the system 3805 can be combined into a single system.

Still further, the system 3805 can have access to the remote systems described above and referenced to FIG. 37 to provide access to medical databases for assistance in diagnosing a particular condition captured by the live streaming of the headphones 110. It will be further understood that the supervisory system 3735 can be monitored by doctors or other medical professionals which can intervene to control the system 3805 in issuing particular instructions or controls to the headphones 110.

In some embodiments according to the inventive concept, the headphones 110 using the local or remote application can support augmented shopping where the user wears the headphones 110 into a commercial outlet while shopping for a particular product or while simply browsing all products. In such operations, the video cameras located on the headphones 110 can be used to stream live video to a remote server which can be used to identify particular products as seen by the user. In response, the remote applications can identify the products provide information related to competitive products including price, performance, physical dimensions, as well as views of those products so that the user may make a more informed decision regarding which product may suit their needs better. In still further embodiments according to the inventive concept, the commercial outlet or retailer may utilize the video stream to determine which products the users are more interested in.

In some embodiments according to the inventive concept, the headphones 110 along with a native or remote application may support services for the visually or hearing impaired. For example, the environment in implementations assisting the visually impaired, the headphones 110 may utilize the cameras located thereon as a “set of eyes” for the user and the video from which can be streamed to a remote server for image processing wherein particular objects can be identified in the user warned of their presence. For example, in some embodiments according to the inventive concept, the camera may stream video to locate a crosswalk on a street and further maybe utilized to determine if traffic is stopped before prompting the wearer to proceed through the crosswalk.

In still further embodiments according to the inventive concept, such as in an audio impaired environment, the headphones 110 can be utilized to provide haptic feedback to the user using some of the same techniques described above in reference to the visually impaired environment. For example, the headphones 110 may let the user provide streamed audio using the microphones thereon to identify the presence of objects which otherwise would not be readily apparent to the users. Still further, the headphones 110 may provide haptic feedback to the user as to the presence of those objects and moreover, may provide haptic feedback in the directional format so that the user is made aware of not only the presence but also the location of the object relative to the user.

In some embodiments according to the inventive concept, the headphones 110 along with the native or remote application can provide a wireless payment system. For example, in some embodiments according to the inventive concept, the headphones 110 may include an NFC and Bluetooth interface which may be utilized to pay wireless in response, for example, voice commands or touch commands on the capacitive touch surface.

In some embodiments according to the inventive concept, the headphones 110 along with the native application and/or remote application can be utilized to provide a motion controlled gaming environment where for example the headphone cameras are used to track devices located in the gaming environment, such as drum sticks or other motion controllers manipulated by the wearer of the headphones. Accordingly, the video cameras can provide additional accuracy in determining the location, movement, orientation of those objects in the gaming environment which may provide a more realistic experience. The video can also be used for motion tracking of the user which can be used to increase the accuracy of other devices used during gaming, such as the motion controller. The video can also be used to provide additional information regard the actions taken be the player where, for example, the player uses drum sticks with accelerometers to accurately track movement of the drum sticks whereas the cameras in the headphones 110 can be used to track the movement of the players head. In some embodiments, data can be transmitted between the drum sticks and the headphones 110.

The streamed video can also be rendered on a display of the gaming action for a more realistic experience. The video of the gaming action can also be streamed to a video server, such as Twitch. In some embodiments according to the inventive concept, feedback from the object manipulated by the user can be provided to the headphones 110 which may in turn provide an audio feedback signal to the user. Still further, the video cameras may be utilized to determine further information regarding movement of the objects manipulated by the user such as the location of the object relative to other items in the environment.

In some embodiments according to the inventive concept, the headphones 110 along with the native or remote application can be utilized to provide voice activated searching whereupon the user may speak a particular command such as “Okay Muzik search” were upon the application converts the audio to a text based search which is then submitted to the remote server. In some embodiments according to the inventive concept, the audio information is transmitted from the headphones to a mobile device or server which translates the audio information to the text which is then forwarded for searching.

In some embodiments according to the inventive concept, the headphones 110 operating with the native or remote applications can be utilized to operate connected devices such as lights, door locks, etc. In such embodiments, the user may speak a particular command (such as okay music) followed by a voice command configured to carry out a particular function associated with a particular device. The audio information can be translated by the native application to text data or alternatively the audio information can be transmitted to the remote application or server for translation to text. The translated text is then forwarded to servers which are configured to determine nature of the command that is intended (such as turn on my lights). That particular command string or instruction is returned to the location associated with the headphones 110 or user whereupon the command is directed to the particular device identified by the remote server.

In some embodiments according to the inventive concept, the headphones 110 can provide an application that implements what is sometimes referred to as a “chatbot”. Accordingly, the chatbot may be implemented in support of a calling or messaging environment wherein the user interacts with a remote calling or messaging system using the local chatbot which is intended to simulate conversation with an intelligent entity and can operate in real time in response to queries by the user. In some embodiments according to the inventive concept, the chatbot can be supported by an automated on-line assistant such as one utilized both for customer engagement, customer support, call direction, or the like. It will be further understood that in each of the implementations described herein the applications native on the headphones 110 as well as the sensors associated with the headphones can be implemented in any of the form factors described herein such as the on-ear, over ear, or in-ear headphones.

In some embodiments according to the inventive concept, the headphones 110 and the native application as well as the remote application can be provided in support of a visually impaired user by using, for example, the video cameras to identify products while shopping and provide audio feedback to the wearer such as cost, product characteristics, costs relative to other products, warranty information, location of other related items, etc. In some embodiments according to the inventive concept, the video cameras can be utilized to identify coupons for products that are examined by the user. In some embodiments, the camera can be used to read braille or used to interpret sign language by the user. For example, the user may sign using the camera where a native or remote application translates the signs to text, email or audio.

In some embodiments according to the inventive concept, the headphones 110 including the native and/or remote application can support a customer service environment wherein the user may request information about a particular product that has been purchased or is being considered for purchase. In such applications, the user may contact the customer service environment as an initial step in exploring the applicability of a particular product which may be then follow up by direct contact by a remote actor using the audio communication to the headphone 110.

In still further embodiments according to the inventive concept, the video cameras can be utilized in a spatial relation environment (such as interior design, construction, etc.) where the user is visualizing items or relationships which may be virtual. In response, a native application or remote application may respond by over laying virtualized objects into the scene that is streamed from the headphones 110.

In some embodiments according to the inventive concept, the headphones 110 can be utilized to calendar a meeting with a particular person or group of persons. For example, the user may indicate that a meeting is to be calendared for a group of people at a particular time and day whereupon the application resident on the headphones 110 or remote from the headphones 110 may respond by forwarding an invitation to each of the members of the group which can be followed up by a reminder forwarded to each of those members closer to the actual scheduled time/date.

In some embodiments according to the invention, the headphones 110 and native and remote applications can be utilized to provide enhanced sensory awareness (such as enhanced vision or hearing) using the video cameras and microphones included with the Headphones 110. For example, in some embodiments according to the invention, the video streamed by the headphones 100 can be processed to identify particular objects where the movement of objects therein may be of particular interest to the user. For example, the user may be somehow impaired and therefore the video stream is processed to identify moving objects nearby the user which may otherwise raise safety concerns. And still other embodiments according to the invention, the user may be visually impaired and therefor enhanced hearing is provided by the microphones to similarly warn the user about objects in the environment. And still further embodiments according to the invention, both the cameras and the microphones can be used to identify objects in the environment which may be of particular interest to the user. It will be further understood that the processing used to recognize the objects can be done natively in the headphones 110 or on a remote server whereupon the processed information is returned to the headphones 110 upon completion.

And still further embodiments according to the invention, the headphones 110 along with a native application or remote application can be streamed to groups associated with a particular end point server, such as Facebook, so that a group of viewers may observe streamed video. And still further embodiments according to the invention, the end point server may not otherwise incorporate a filter upon content which may be provided.

And still further embodiments according to the invention, native voice over IP calling applications can be preloaded on the headphones 110 which may enable the user to make low cost or free call, as well as send low cost or free messages to individuals or groups in response to voice commands.

In some embodiments according to the invention, a native application can provide foreign language translations such that the foreign language can be translated in real time to the user's native language. In such embodiments according to the invention, the user may wear the headphones 110 around the neck wherein the earcups are rotated to point upward in the direction of the foreign language speakers. In operation, the foreign language audio is received by the microphones on the headphones 110 which is then converted to the native language of the user.

In some embodiments according to the invention, the headphones 110 can be connected to a cloud backend that is preloaded with cognitive services used for speech text, text to speech, image recognition, facial recognition, language translation, searching, bots as well as other types of artificial intelligence services.

In some embodiments according to the invention, a user may operate as a “DJ” that generates a playlist to which other users may subscribe or listen in on. In operation, the DJ user could generate playlists and issue an invitation to other user or followers so that those users may hear the music included in the playlist. Moreover, data may be transmitted to the user's headphones so that the audio content can be indexed directly to where the DJ user is listening so that both the DJ user as well as the users can listen to the music at essentially the same point.

In some embodiments according to the invention, the earcups of the headphones 110 are removable and include unique identifiers so that the type of cushion can be determined by the headphones 110. Accordingly, when on ear cushions are placed on the headphones 110 the music equalization can be set to a predetermined configuration whereas when over ear cushions are coupled to the headphones 110, the equalization can be changed to a more optimized setting.

In some embodiments according to the invention, the headphones 110 may be used in analog mode such that an audio cable can be used to connect the headphones 110 to the Mobile Device 130 while also streaming live video from the headphones 110. Accordingly, the video and analog can essentially provide from one another but essentially concurrently.

In some embodiments according to the invention, the headphones 110 can automatically download features from a remote server upon request by the user or upon request for a particular function that is not supported in the present configuration. Accordingly, when a user requests a particular function which is not supported, the headphones 110 may prompt the user for authorization to download a version of an application which supports the requested feature.

In some embodiments according to the invention, the headphones 110 can monitor and learn the behavior of the user which then can be utilized by an artificial intelligence to provide suggestions to the user relevant used based on interest, used to call transportation services by reference to a location system associated with the headphones 110, monitor biometric readings of the user, or by monitoring activities of the user which can be associated with levels of stress such as frequency of phone calls, the frequency of calendar appointments, non-movement of the user, etc.

In some embodiments according to the invention, the headphones 110 can be incorporated as part of a system where users subscribe to the paid or ad supported model where the headphones 110 can be provided, along with all software, for a monthly payment. For example, the user may provide a down payment which may entitle the user to a monthly fee for all services and hardware. Alternatively, the user may opt for an ad supported model wherein the video camera on the headphones 110 is used to capture local information which can, in turn, be used to provide advertising which is tailored to the user based on data collected by the headphones 110. In still further embodiments according to the invention, the user operating under the ad supported model would review products every day in a commercial outlet or hear live ads from an advertiser to offset cost of the subscription. For example, in some embodiments according to the invention, the user may look at a particular product using the headphones 110 whereupon the object is scanned and uploaded to the cloud for processing by cognitive software whereupon the remote server indicates using, for example, audio feedback to the user which identifies the product, whereupon the user acknowledges whether the provided feedback correctly identifies the product and a live advertising is played to the user.

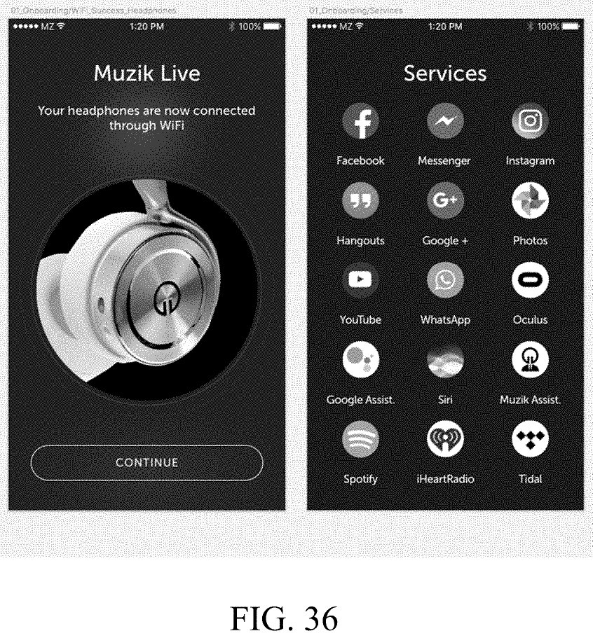

FIG. 36 is a schematic representation of a series of screens presented on the mobile device 130 running an application configured to connect the headphones 110 to the application for syncing in some embodiments according to the invention. According to FIG. 36, a user may choose to sync their mobile device running the application shown to the headphones 110. It will be further understood, that the headphones 110 can be synced to any device that is associated with a screen such as a TV, tablet, AR/VR system, smart watch, etc.

Once the headphones 110 are synced to the application, the user can select an app from among the services that they wish to link to the headphones 110. The users may enter passwords or choose other settings where upon the user can interact with the selected app using voice commands. For example, the user may speak “Facebook live, start” to start the Facebook live application, or speak “Spotify play Drake” to begin playing music from Spotify to the headphones 110, or “messenger, Fred ‘I will be home in 30 minutes’” to send a message to Fred using messenger or speak “Instagram, take picture” to take a picture using the Instagram application which is linked to the application.

In some embodiments according to the invention, applications running on the headphones 110 in the background can be enabled in response to voice commands can perform features and actions described herein in reference to FIGS. 1-36 as well as monitor behavior of the user based on the sensor input coupled to the headphones. Furthermore, a particular application running in the background may be configured to periodically ask questions of the user whereupon the responses can be forwarded to a remote server (or processed by a native application) to monitor the users behavior and habits to determine the likelihood that particular products may be of interest to the user. Still further, the application may ask questions associated with polling or make recommendations regarding health or wellness based on biometric sensor input or monitored sensors associated with the headphones 110. For example, the headphones 110 may communicate to remote server that the user participates in meditation in a particular time such as before work and make further note that the user's performance at work should be monitored to determine if the meditation provides any objective benefits, such as more alert behavior, more collaboration, etc. compared to users who do not meditate or practice some other behaviors such as listening to music. In further environments, the learned behavior accumulated by the headphones 110 can identify certain idiosyncrasies associated with the user and suggest particular applications for the users benefit or alternatively, new applications having particular features which are determined to be the likely of interest to the user can be suggested.

In some embodiments according to the invention, the systems methods and devices described herein can take the form factor of a Head-worn Computer complete with an operating system as described herein and as depicted, for example, in FIG. 10. In such embodiments, all of the functionality of a conventional mobile device, such as a smart phone, and its accompanying applications can be provided by the Head-worn Computer system. Still further, the Head-worn Computer can operate as part of a subscription based service where the user pays the monthly fee in exchange for the functionality described herein such as calling, live video streaming, music streaming, telemedicine capabilities, access to education classes, accessibility support for the hearing and visually impaired, motion controlled gaming, etc.

In still further embodiments according to the invention, the Head-worn Computer (or Headphones 110) can provide the platform for a mobile communications system that provides unlimited calling and messaging along with other enhanced services such as group calling for teens, group messaging for teens, group listening to streaming services, etc. It will be further understood that the support for the mobile plan can be provided through an SDK configured to support specific applications such as Facebook Messenger and Watsapp.

It will be understood that in some embodiments according to the invention, live streaming of video can be configured for ingestion by social media services such as Facebook, Twitter, Snapchat, YouTube, Instagram, and Twitch. Other services may also be used.

It will be further understood that live streaming of audio can be provided from the Headphones 110 or the Head-worn Computer system in conjunction with services such as Spotify, YouTube Music, Title, iHeartRadio, Pandora, Sound Cloud, Apple Music, and Shazam. Other audio services may also be used.

In some embodiments according to the invention, it will be understood that the calling applications described herein and provided by the Headphones 110 or the Head-worn Computer can be configured to operate with applications such as Skype, Slack, Facebook workplace, Twilio, WatsApp, G Talk, Twitch, Line, and WeChat. Other calling application may also be supported.

And still further embodiments according to the invention, it will be understood that the Headphones 110 or the Head-worn Computer can be configured to operate with applications such as Facebook Messenger, WatsApp, Skype, Wechat, Line, Google, and Facebook Messenger. Other messaging applications may also be supported.

In some embodiments according to the invention, it will be understood that the Headphones 110 or the Head-worn Computer can be configured to support health and wellness applications such as the brand Jordan or Puma, motion tracking, sleep tracking, meditation, stress management, telemedicine, WebMD (utilized for identifying potential illnesses), Sharecare, and MD live. Other health and wellness applications may also be supported.

It will be also understood that in some embodiments according to the invention, the Headphones 110 or the Head-worn Computer can be configured to support education applications such that class lessons can be recorded and made available online, live streaming or offline streaming can be provided on demand for remote locations, language translation can also be provided, camera identification of historical or art object, general image recognition, voice control, reading of braille, and text to speech. Other education type applications may also be supported.

It will be also understood that in some embodiments according to the invention, the Headphones 110 or the Head-worn Computer can be configured to support accessibility type applications such as sign language control wherein the video camera can be used to identify particular signs as part of sign language (which can then provide the basis for control of the headphones or the Head-worn Computer), can provide functionality to replace what is commonly referred to as a seeing eye dog to assist the visually impaired in safely traveling through the environment, custom hearing tests with tools to diagnose hearing issues, predictive noise cancellation, access to emergency services, detection of abduction which can automatically activate the camera and GPS associated with the Headphones 110 and the Head-worn Computer system. Other associability applications may also be supported.

And still further embodiments according to the invention, the Headphones 110 or the Head-worn Computer can be configured to provide business to business type applications which can for example connect teams using live video, group calls (including recording calls, taking notes, linking to calendars, contacts, sharing call notes or voice recordings), group messaging, customer service immigration (where it may access customer service for a particular product that is seen by the video cameras or for the Headphones or the Head-worn Computer itself), construction, interior design, mapping applications, access to news, personal calendars, a personal assistant, where for example a best price can be obtained by viewing the product using the video cameras.

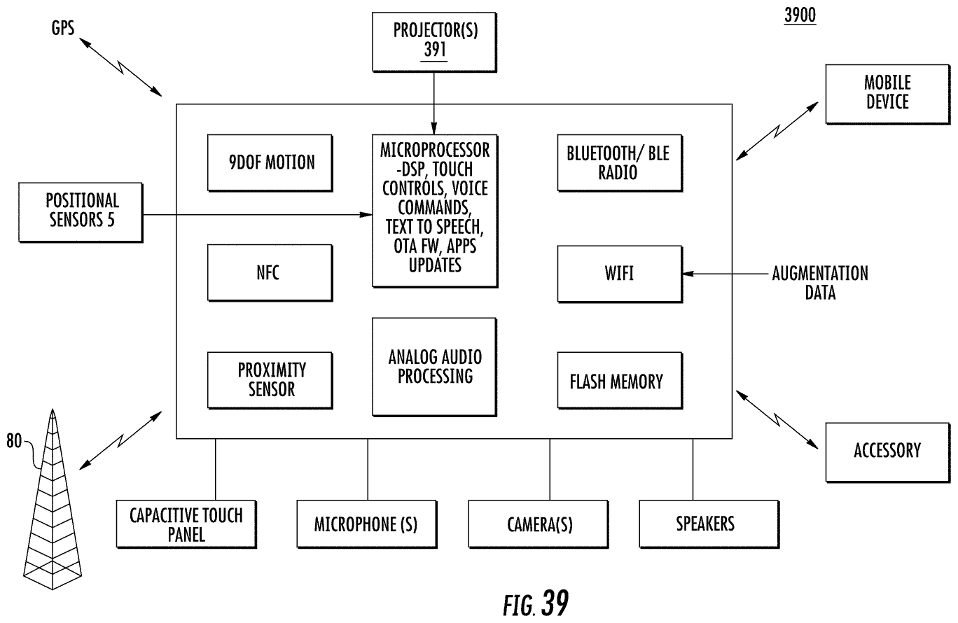

FIG. 39 is a block diagram of a wearable computer system 3900 including at least one integrated projector 3901 in some embodiments according to the invention. According to FIG. 39, the wearable computer system 3900 may be, in some embodiments according to the invention, audio/video enabled headphones capable of live streaming video to a remote server with at least one integrated projector 3901 for providing an immersive augmented reality experience for the wearer of the computer system 3900. It will be understood that many of the elements shown in FIG. 39 can be analogous to those shown in FIG. 3 above and described in conjunction therewith in the specification. Accordingly, each of the functions described for example in reference to FIG. 3 can also be provided by the computer system 3900 shown in FIG. 39. In addition, the computer system 3900 includes at least one projector 3901 operatively coupled to the microprocessor which can be used to provide projected video output onto an arbitrary surface.

In operation, the computer system 3900 can be utilized to provide an immersive augmented reality experience for the user as described, for example, in reference to FIGS. 20-23. Accordingly, the computer system 3900 can be equipped with sensors 5 that can be utilized to provide positional data for the computer system 3900 as it moves through an environment. During the immersive experience, the movement of the wearable computer 3900 may be tracked using the sensors 5 so that the user may be provided with a more realistic experience by determining, for example, head movement or movement of the user's body within the environment, which can be used to alter the perspective of the video shown via the projector 3901.

A further shown in FIG. 39, the feature 80 can be used as a reference by the computer system 3900 to determine positional data within the environment as described above in reference to, for example, FIG. 22. Still further, the computer system 3900 may be operatively coupled to a GPS system as shown in FIG. 39 to provide geographic positional information to the computer system 3900 as it moves beyond the local environment which may be out of range of the feature 80. It will be further understood that although one feature 80 is shown in FIG. 39, additional features may also be used for reference by the wearable computer system 3900. It will be further understood that the sensors 5 can also include emitting devices such as sonar or lidar, radar, or other sensors that can be utilized by the computer system 3900 to determine (at least partially or incrementally) the positional data for the wearable computer system 3900.

Still further as shown in FIG. 39, the computer system 3900 can receive augmentation data from a plurality of sources for combination with other information provided by, or to, the computer system 3900 and projected via the projector 3901 for viewing by the wearer of the computer system 3900. For example, in some embodiments according to the invention, the augmentation data may be provided by a gaming application and combined with the positional data determined by the computer system 3900 which can be rendered by the computer system 3900 and projected by the projector 3901 for viewing by the user during game-play. Still further, as the wearable computer 3900 moves throughout the environment, the rendering of the combined data can be modified so that the projector 3901 provides a more realistic view of the perspective provided to the user.

As further shown in FIG. 39, the computer system 3900 can also receive data from a mobile device (or an application executing on a mobile device) for display by the projector 3901. For example, in some embodiments according to the invention, the mobile device may provide a representation of a video output which would normally be provided on a display the mobile device. In operation, the computer system 3900 can relay the display information provided received from the mobile device to the projector 3901 for display on an arbitrary surface. In such embodiments, the wearable computer system 3900 can be used to generate a large format virtual display from a relatively small format display integrated with a mobile device. Accordingly, the limitations associated with a relatively small screen provided by the mobile device can be improved by projecting the display of the mobile device to a larger format so that the user of the computer system 3900 may view the display more clearly without the need for a large format electronic device (such as a monitor). Accordingly, the computer system 3900 may be used to provide a convenient large format display regardless of the format provided by the mobile device. In other words, the mobile device can be any device that provides a video output for reproduction via the projector 3901. In still further embodiments according to the invention, multiple mobile devices may be in communication with the computer system 3900 which may be then combined onto a single composite display that is provided by the projector 3901 onto the arbitrary surface. In some embodiments according to the invention, the arbitrary surface can be any surface that is suitable for a display of an image thereon and can be any size that is desired for the display. For example, in some embodiments according to the invention, the surface can be the back of an airplane seat or a piece of paper or the user's hand. It will be further understood that the surface can have an arbitrary orientation relative to the user. The projector 3901, however, may be adjustable to compensate for the orientation of the surface relative to the user so that the image projected onto the surface may be substantially rectangular. In some embodiments, the mobile device can be an electronic watch or other accessory includes a small format display. In some embodiments, the mobile device can be an electronic device that does not include a display.

As further shown in FIG. 39, the computer system 3900 can include at least one camera (which can provide still images and/or video images) which may be combined with data that is to be projected onto the surface. For example, in some embodiments according to the invention, the camera may be used to sample the surrounding environment and a projected image can be generated based on the capture image augmented with an overlay of the augmentation data shown at FIG. 39. The camera may be independently adjustable to sample the appropriate scenes despite the orientation of the computer system 3900 relative to the surface on which the image is to be projected.

Still further, FIG. 39 shows that various accessories can be wirelessly coupled to the computer system 3900. In some embodiments according to the invention, the accessory can be the electronic devices associated with a gaming system such as a wand, drumsticks, or generic device which can be used to participate in an electronic game. For example, in some embodiments according to the invention, the accessory can be a set or drumsticks which are configured to provide the functionality described in U.S. patent application Ser. No. 15/090,175 (“the '175 application”) entitled Interactive Instruments and Other Striking Objects filed Apr. 4, 2016, the entire disclosure of which is incorporated herein by reference. In such embodiments, an image of a virtual drum set may be generated and projected onto a surface via the projector 3901. The user may then utilize the drum sticks to play the virtual drum set as described in the '175 application. Other accessories may also be used. Still further, an API can be provided to access the computer system 3900.

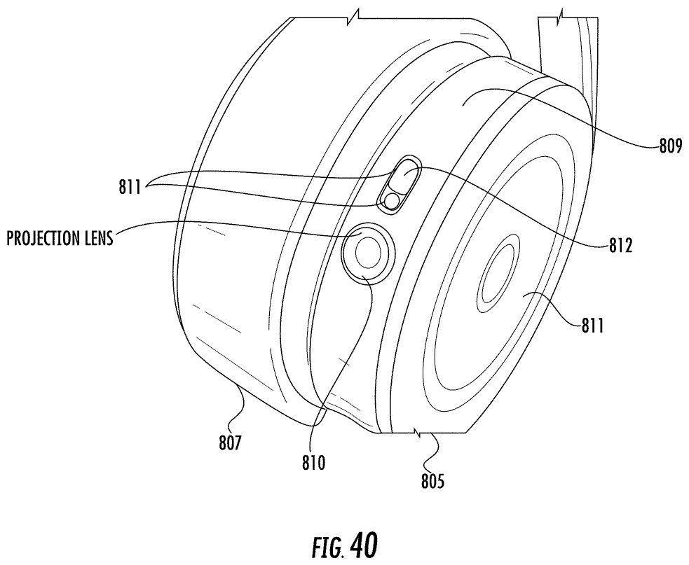

FIG. 40 is a schematic representation of an earcup of the computer system 3900 as a set of headphones equipped with cameras and projector 3901 in some embodiments according to the invention. According to FIG. 40, the projector lens 409 can be located on a movable bezel 809 which rotates so that the projector 3901 can be oriented up or down relative to the user's placement of the wearable computer system on the head. Accordingly, the surface on which the image is to be projected can be more conveniently located by rotating the camera lens 409 to compensate for the orientation of the earcup relative to the surface.

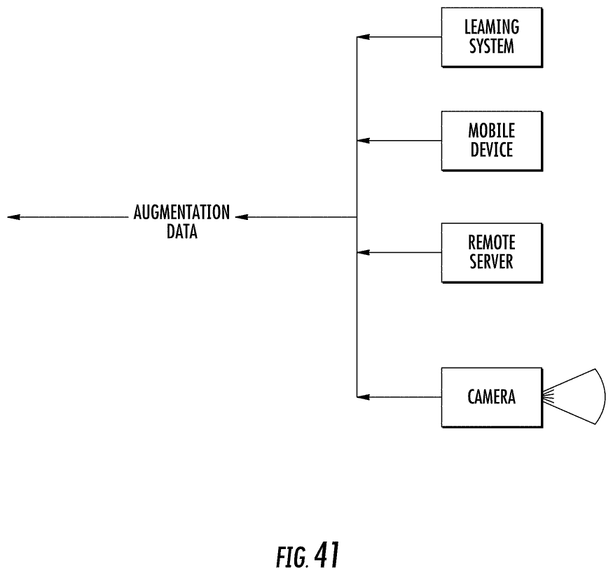

FIG. 41 is a schematic diagram illustrating various sources of augmentation data which can be overlaid or combined with images to be projected. In some embodiments according to the invention, the augmentation data can be data provided by a gaming system such as scenes rendered as part of a first person shooter application which may include remote participants in the game that are competing with the user of the computer system 3900.

In still further embodiments according to the invention, the augmentation data can be provided by a remote server which can provide various types of data to be overlaid with images that can be generated by the camera included with the wearable computer system 3900. For example, in some embodiments according to the invention, the remote server may provide anatomical data that can be projected onto a body of a patient so that the user may view the relative positions of internal organs when viewing the patient. Accordingly, in operation, the camera may sample the image of the patient whereupon the remote server provides the anatomical data for augmentation so that the processor in the wearable computer system 3900 registers the image data relative to the augmentation data so that the internal anatomical images are overlaid correctly onto the image of the patient so the organs appear in the proper position. It will be understood that this embodiment can be combined with the telemedicine embodiments described herein.

In still further embodiments according to the invention, the user may stand in front of a mirror and sample an image of themselves using the camera. The remote server may provide augmentation data that represents clothing which can be overlaid and rendered with a sample image from the mirror so that the projected image combines the clothing data with the sampled image so that the user may view themselves as if the clothes were being worn. In some embodiments, registration of the user's image can be provided by the wearable computer so that the overlaid clothing can be properly rendered onto the image of the user. In some embodiments, the color, size, style, tailoring, and the like can be changed by the user whereupon the augmentation data representing the clothing may be modified to provide the changes selected. In some embodiments, the clothing can be associated with an electronic catalogue that the user can refer to when selecting clothing for viewing. In some embodiments, the clothing can be associated with a hardcopy catalogue that the user can refer to when selecting clothing for viewing wherein the camera can be used to sample the image or product code which can be used to request the corresponding augmentation data from the remote server.

In still further embodiments according to the invention, the augmentation data can include construction information such that an inspection of a building could be provided by sampling a video of a building and overlaying the image with the construction blueprints so that an inspector can view internal components without opening the walls. Again, proper registration would occur between the augmentation data than comprises the blueprints and the sampled image of the interior of the building so that the components included in the blueprints are shown in the proper position relative to the sampled image.

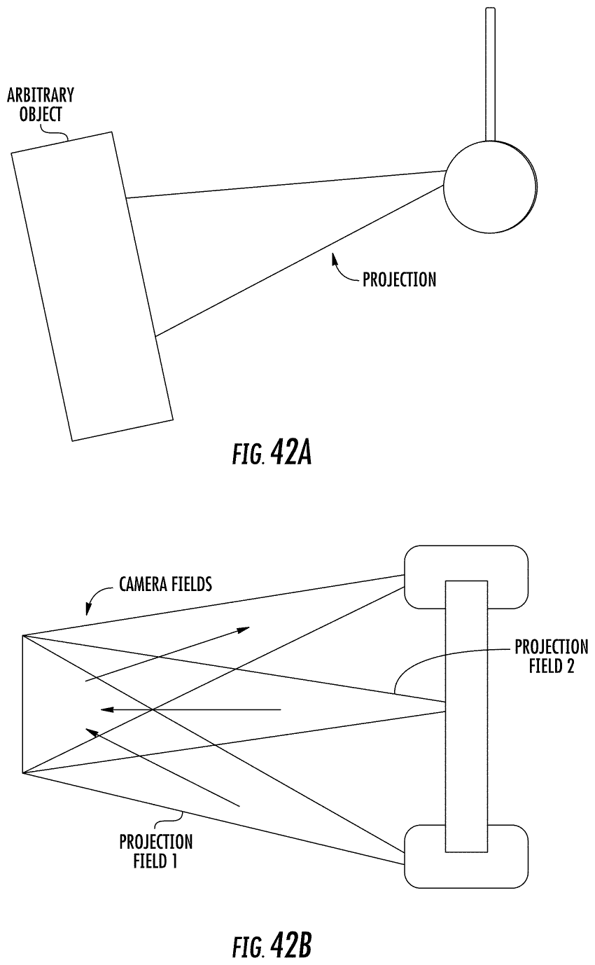

FIG. 42A is a schematic representation of the computer system 3900 as a pair of headphones generating a projection 4205 onto an arbitrary surface 4201 at an arbitrary orientation relative to the system 3900. As discussed above in referenced to FIGS. 39 and 40, the projector lens is movable relative to the earcup on the headphones so that the projection can be viewed with an appropriate aspect ratio despite the arbitrary orientation of the surface relative to the headphones.

FIG. 42B is an alternative view of the headphones shown in FIG. 42A including multiple projectors: one on one of the earcups and another on the center of the headband. Still further, FIG. 42B shows that the camera can be located on the opposite earcup relative to the first projector. As further shown in FIG. 42B, projection field 1 can be oriented onto the surface for viewing along with image provided by projection field 2 so that the two projection fields completely align with one another on the surface. Accordingly, the first and second projectors can be used to provide different components of the same image so that, for example, a three dimensional image may be generated by the system 3900. Still further, the camera field sampled by the camera shown on the opposite earcup can sample the image generated by the over laid first and second projection fields for transmission to a remote server.

As will be appreciated by one of skill in the art, various embodiments described herein may be embodied as a method, data processing system, and/or computer program product. Furthermore, embodiments may take the form of a computer program product on a tangible computer readable storage medium having computer program code embodied in the medium that can be executed by a computer.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wired, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computer environment or offered as a service such as a Software as a Service (SaaS).

Some embodiments are described herein with reference to flowchart illustrations and/or block diagrams of methods, systems and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

Although various features of the invention may be described in the context of a single embodiment, the features may also be provided separately or in any suitable combination. Conversely, although the invention may be described herein in the context of separate embodiments for clarity, the invention may also be implemented in a single embodiment.

That which is claimed:

1. A head mounted system comprising a composite display system, the composite display system comprising:
a video camera configured to provide image data;
a wireless interface circuit configured to transmit the image data to a portable electronic device that is remote from the head mounted system; and
a processor circuit, coupled to the video camera and to the wireless interface circuit, the processor circuit configured to transfer the image data to the portable electronic device via the wireless interface circuit to provide a first person view from a perspective of the video camera on the portable electronic device, wherein the portable electronic device is configured to combine the first person view with a selfie-view generated by the portable electronic device and display a composite image including the first person view and the selfie-view on a display of the portable electronic device.

2. The head mounted system of claim 1 further comprising:
an audio circuit, coupled to the processor circuit, the audio circuit configured to provide audio data associated with image data, wherein the processor circuit is further configured to transfer the audio data to the portable electronic device.

3. The head mounted system of claim 1, further comprising:
a plurality of positional sensors, coupled to the processor circuit, wherein the plurality of positional sensors are configured to provide a position of the head mounted system using six degrees of freedom.

4. The head mounted system of claim 3 wherein the plurality of positional sensors are configured to detect electromagnetic and/or physical signals used to determine positional data for the system.

5. The head mounted system of claim 4 wherein the plurality of positional sensors comprise video or still cameras configured to capture images of an environment within which the system is located, and wherein the processor circuit is configured to determine positional data based on the images.

6. The head mounted system of claim 4 wherein the plurality of positional sensors comprise RFID sensors configured to determine the position of the system based on triangulation of radio signals.

7. The head mounted system of claim 4 wherein the plurality of positional sensors comprise accelerometers configured to determine an orientation and/or movement of the system based on detected movement of the accelerometers.

8. The head mounted system of claim 4 further comprising:
an augmentation processor configured to augment operations of the system responsive to a request and/or data provided to the system and configured to return a result of the request and/or data provided to the system.

9. The head mounted system of claim 8 wherein the augmentation processor is configured to operate responsive to the request and/or data provided to the system from a separate electronic device outside the system.

10. The head mounted system of claim 9 wherein the augmentation processor is configured to perform calculations and/or other operations related to the request and/or data provided to the system and provide a response to the separate electronic device.

11. A head mounted system comprising:
a video camera configured to provide image data;
a wireless interface circuit configured to transmit the image data to a portable electronic device that is remote from the head mounted system, and to receive augmentation data from a remote server; and
a processor circuit, coupled to the video camera and to the wireless interface circuit, the processor circuit configured to transfer the image data to the portable electronic device via the wireless interface circuit, and to register the image data with the augmentation data and combine the image data with the augmentation data to provide augmented image data.

12. The head mounted system of claim 11, further comprising a projector circuit, coupled to the processor circuit, the projector circuit configured to project augmented image data from the head mounted system.

13. The head mounted system of claim 12, wherein the augmented image data is projected onto a surface.

14. The head mounted system of claim 11, further comprising:
a plurality of positional sensors, coupled to the processor circuit, wherein the plurality of positional sensors are configured to provide a position of the head mounted system using six degrees of freedom.

15. The head mounted system of claim 14 wherein the plurality of positional sensors are configured to detect electromagnetic and/or physical signals used to determine positional data for the system.

16. The head mounted system of claim 15 wherein the plurality of positional sensors comprise video or still cameras configured to capture images of an environment within which the system is located, and wherein the processor circuit is configured to determine positional data based on the images.

17. The head mounted system of claim 15 wherein the plurality of positional sensors comprise RFID sensors configured to determine the position of the system based on triangulation of radio signals.

18. The head mounted system of claim 15 wherein the plurality of positional sensors comprise accelerometers configured to determine an orientation and/or movement of the system based on detected movement of the accelerometers.

19. The head mounted system of claim 11, wherein the portable electronic device is a mobile device.

20. The head mounted system of claim 11, further comprising:
a headphone apparatus comprising two audio output components, respective ones of which comprise an audio driver and are each configured to couple to a portion of an ear of a user of the head mounted system and further comprising a video camera configured to provide image data;
network communication interface configured to communicate between the headphone apparatus and a portable electronic device;
a touch input sensor disposed on one of the two audio output components of the headphone apparatus; and
an input recognition circuit communicatively coupled to the touch input sensor, wherein the input recognition circuit is configured to:
receive a first association between a touch input and a first command to be executed on the portable electronic device, wherein the first command instructs the portable electronic device to transmit a message to a server external to the portable electronic device and the head mounted system, and wherein the message that is transmitted to the server comprises information related to audio information received at the head mounted system and video data when the touch input is received;
receive a first instance of the touch input provided by the user to the touch input sensor after receiving the first association;
determine that the first instance of the touch input matches the first association between the touch input and the first command to be executed on the portable electronic device;
provide the first command, responsive to the first instance of the touch input matching the first association, to the portable electronic device for execution;
receive a second association between the touch input and a second command to be executed on the portable electronic device;
receive a second instance of the touch input provided by the user to the touch input sensor after receiving the second association;
determine that the second instance of the touch input matches the second association between the touch input and the second command to be executed on the portable electronic device; and
provide the second command, responsive to the second instance of the touch input matching the second association, to the portable electronic device for execution.
